(19) United States
(12) Patent Application Publication
(10) Pub. No.: US 2025/0245044 A1
(43) Pub. Date: Jul. 31, 2025

(54) Process Orchestration Method and Apparatus, Electronic Device and Storage Medium

(71) Applicant: BOT Holding Limited, Road Town (GB)

(72) Inventors: Lei SHI, Road Town (GB); Xun QIAO, Road Town (GB); Pei HUA, Road Town (GB); Yuyun BAO, Road Town (GB); Dong ZHANG, Road Town (GB)

(73) Assignee: BOT Holding Limited, Road Town (GB)

(21) Appl. No.: 18/663,095

(22) Filed: May 14, 2024

(30) Foreign Application Priority Data
Jan. 25, 2024 (CN) 202410107817.2

(51) Int. Cl. G06F 9/48; G06F 9/38

(52) U.S. Cl. CPC G06F 9/4881; G06F 9/3836

(57) ABSTRACT

A process orchestration method, a process orchestration apparatus, an electronic device and a storage medium are provided. The method includes: generating a to-be-orchestrated service process, in response to a node selection operation and a node parameter configuration operation based on an interface, wherein nodes supported for selection by the node selection operation include synchronous nodes and asynchronous nodes, wherein the synchronous nodes represent tasks which can be executed without waiting for an external action, and the asynchronous nodes represent tasks which need to wait for an external action to be executed; and executing the nodes in the service process successively according to an order of the nodes in the service process.

### TECHNICAL FIELD

The present disclosure relates to the technical field of computer application, and specifically to a process orchestration method, a process orchestration apparatus, an electronic device and a storage medium.

### BACKGROUND ART

Process orchestration refers to organization of various tasks involved in a certain executable process through an orchestration engine according to an execution order thereof. However, the orchestration capability of existing orchestration engine is weak, while the tasks involved in a practical service process are usually diversified; therefore, the existing orchestration engine cannot adapt to diversified orchestration requirements of the practical service process.

### SUMMARY

Embodiments of the present disclosure aim at providing a process orchestration method, a process orchestration apparatus, an electronic device and a storage medium, for solving the problems that the existing orchestration engine cannot adapt to the diversified orchestration requirements of the practical service process and the orchestration engine has poor usability.

In the first aspect, embodiments of the present disclosure provide a process orchestration method, including: generating a to-be-orchestrated service process, in response to a node selection operation and a node parameter configuration operation based on an interface, wherein nodes supported for selection by the node selection operation include synchronous nodes and asynchronous nodes, wherein the synchronous nodes represent tasks which can be executed without waiting for an external action, and the asynchronous nodes represent tasks which need to wait for an external action to be executed; and executing the nodes in the service process successively according to an order of the nodes in the service process.

The above method may be applied to the process orchestration engine. During the above implementation, the to-be-orchestrated service process is generated by the user executing the node selection operation and the node parameter configuration operation on the interface, thereby implementing the visual process orchestration. Such orchestration does not require writing a large amount of codes, so that the efficiency of process orchestration is improved, the possibility of code syntax errors is reduced, and thus the service process orchestration is more intuitive and friendly to operate for ordinary users.

Meanwhile, in the node selection operation, the nodes supported for selection include the synchronous nodes and the asynchronous nodes, that is, in the service process, the synchronous nodes may be orchestrated to implement tasks which can be executed without waiting for the external action, and the asynchronous nodes also may be orchestrated to implement tasks which need to wait for the external action to be executed (the two types of nodes definitely also may be orchestrated simultaneously), so that the obtained service process may effectively describe diversified task types in practical service, and thus the problem that the existing orchestration engine cannot adapt to the orchestration requirement of the practical service process is solved, and the compatibility and usability of the orchestration engine are improved.

Optionally, in the embodiments of the present disclosure, attributes of the nodes include node identifier, process instance identifier and branch identifier, wherein the node identifier is used to identify different nodes in the service process; each time the service process runs, one process instance is generated, and the process instance identifier is used to identify the process instance to which the node belongs; and the process instance includes one or more branches, and the branch identifier is used to identify a branch to which the node belongs; and the branch is a concurrent execution branch in the process instance.

During the above implementation, by introducing the branches to the process instance, the execution efficiency of the process is improved. Meanwhile, by respectively setting the attributes of the nodes, such as the node identifier, the process instance identifier and the branch identifier, different entities involved in the execution of service process are distinguished, which is conducive to ensuring the accuracy and reliability of the process execution.

Optionally, in the embodiments of the present disclosure, if the external action corresponding to the asynchronous node is an action of a user submitting data on a target page, a step of executing the asynchronous node includes: obtaining the node identifier, the process instance identifier and the branch identifier of the asynchronous node; splicing the node identifier, the process instance identifier and the branch identifier of the asynchronous node, so as to generate an address of the target page; notifying the user executing the external action corresponding to the asynchronous node of the address of the target page in a preset method; and receiving data submitted by the user on the target page, wherein the data includes service data, and the node identifier, the process instance identifier and the branch identifier of the asynchronous node.

During the above implementation, the node identifier, the process instance identifier and the branch identifier of the asynchronous node are spliced, so as to generate the address of the target page, and notify the user of the address of the target page, so that the user, when submitting the data on the target page, may submit the node identifier, the process instance identifier and the branch identifier of the asynchronous node together. A branch under the process instance to which the asynchronous node belongs may be located through these identifiers, so as to continue to execute the nodes after the asynchronous node. That is, through the above implementation, the asynchronous node is supported at an execution level, thereby effectively enhancing the compatibility and usability of the process orchestration engine.

Optionally, in the embodiments of the present disclosure, a node pointer is provided for each branch in the process instance, and the node pointer points to a node currently executed in the branch, and after the data submitted by the user on the target page is received, the method further includes: obtaining the node identifier, the process instance identifier and the branch identifier of the asynchronous node from the data submitted by the user; determining a target node pointer based on the process instance identifier and the branch identifier, wherein the target node pointer refers to the node pointer corresponding to the process instance and the branch to which the asynchronous node belongs; and if the node identifier of the asynchronous node is consistent with the node identifier of the node to which the target node pointer points, continuing to execute nodes after the asynchronous node in the service process.

During the above implementation, the node pointer points to the node currently executed in the branch, the target node pointer is determined using the process instance identifier and the branch identifier in the data submitted by the user, and whether execution is continued is judged by comparing the node identifiers, so as to control and manage forwarding of the execution logic among the nodes in the process instance, thereby ensuring accuracy and reliability of the process execution.

Optionally, in the embodiments of the present disclosure, the target page includes a form page or an examination and approval page.

During the above implementation, the target page includes the form page or the examination and approval page. Target pages in different forms may implement different services, which is conducive to improving the usability of the process orchestration engine, and particularly makes it suitable for some enterprise scenarios (because in enterprises, filling in forms and approval and examination are common services).

Optionally, in the embodiments of the present disclosure, if the target page is a form page of an edited form, the step of splicing the node identifier, the process instance identifier and the branch identifier of the asynchronous node so as to generate an address of the target page includes: acquiring the form instance identifier corresponding to the edited form; splicing the node identifier, the process instance identifier and the branch identifier of the asynchronous node as well as the form instance identifier, so as to generate the address of the target page, wherein the form instance identifier is used to query form data of the edited form, and the form data is used to render the target page; and the data submitted by the user on the target page includes: the updated form data, the node identifier, the process instance identifier and the branch identifier of the asynchronous node, and the form instance identifier.

During the above implementation, in the case where the target page is the form page of the edited form, the form instance identifier may be spliced in the address of the target page, so that the form data of the edited form may be queried according to the form instance identifier, and the form data is presented to the user on the target page, so that the user may re-edit on the basis of the edited form, thereby implementing reuse of the form data. When submitting the new form data, in addition to submitting the node identifier, the process instance identifier and the branch identifier of the asynchronous node, the user further submits the form instance identifier together, so that the process orchestration engine may manage the updated form data based on the form instance identifier.

Optionally, in the embodiments of the present disclosure, preset methods of notifying a user for the external action corresponding to the asynchronous node include: a first method: obtaining user information of the user executing the external action corresponding to the asynchronous node, and sending notification information to the user based on the user information, wherein the notification information includes the address of the target page; a second method: obtaining a to-do item list of the user, and generating a target representative item according to the address of the target page, wherein the target representative item is used to instruct the user to enter the target page; and adding the target representative item to the to-do item list of the user; and a third method: obtaining a data list of the user; generating an interaction button based on the address of the target page, wherein the interaction button is used to instruct the user to enter the target page; and adding the interaction button to the data list of the user.

During the above implementation, diversified and flexible methods of notifying the user are provided, and a corresponding method may be chosen according to specific application scenarios and page requirements of the target page, so that the user acquires the address of the target page, thereby entering the target page to complete the external action corresponding to the asynchronous node.

Optionally, in the embodiments of the present disclosure, if the external action corresponding to the asynchronous node is an action of a third party calling back a target function, the step of executing the asynchronous node includes: storing the node identifier, the process instance identifier and the branch identifier of the asynchronous node in association with a function identifier of the target function corresponding to the asynchronous node; sending the function identifier to the third party by calling an interface provided by the third party; and determining the node identifier, the process instance identifier and the branch identifier of the asynchronous node stored in association with the function identifier in response to the third party calling the target function through the function identifier, according to the function identifier of the called target function.

During the above implementation, the external action corresponding to the asynchronous node also may be the action of the third party calling back the target function. By sending the function identifier to the third party, the node identifier, the process instance identifier and the branch identifier of the asynchronous node stored in association with the function identifier are determined according to the function identifier of the called target function. Through these identifiers, the branch under the process instance to which the asynchronous node belongs may be located, so that the nodes after the asynchronous node continue to be executed. That is, through the above implementation procedure, the asynchronous node is supported at the execution level.

In addition, it also may be seen that the asynchronous node in the embodiments of the present disclosure may support external actions in many application scenarios (for example, people-executed actions such as filling in form and examination and approval, and machine-executed function callback action), so as to better meet diversified orchestration requirements of practical service process, and effectively enhance compatibility and usability of the process orchestration engine.

Optionally, in the embodiments of the present disclosure, a node pointer is provided for each branch in the process instance, and the node pointer points to a node currently executed in the branch, and after the node identifier, the process instance identifier and the branch identifier of the asynchronous node stored in associated with the function identifier are determined, the method further includes: determining a target node pointer based on the process instance identifier and the branch identifier of the asynchronous node, wherein the target node pointer refers to the node pointer corresponding to the process instance and the branch to which the asynchronous node belongs; and if the node identifier of the asynchronous node is consistent with the node identifier of the node to which the target node pointer points, continuing to execute the nodes after the asynchronous node in the service process.

During the above implementation, by comparing the node identifier of the asynchronous node with the node identifier of the node to which the target node pointer points to see whether they are consistent, it is judged whether to continue to execute the nodes after the asynchronous node, so as to control and manage forwarding of the execution logic among the nodes in the process instance, thereby ensuring accuracy and reliability of the process execution.

Optionally, in the embodiments of the present disclosure, the nodes include a loop node, the loop node is a node that requires repeated execution of a child node in a loop body until a loop ending condition is met; and parameters of the loop node include concurrent attribute; when the loop node is to be executed, if the concurrent attribute of the loop node is configured to be concurrent execution, secondary branches, whose number is the same as a total number of values of a loop variable of the loop node, are generated under a branch to which the loop node belongs; and the loop body under each value of the loop variable is concurrently executed using the secondary branches; and when the loop node is to be executed, if the concurrent attribute of the loop node is configured to be non-concurrent execution, the loop body is repeatedly executed according to change of the loop variable using the branch to which the loop node belongs.

During the above implementation, the nodes include the loop node, and the concurrent attribute of the loop node may be configured to be concurrent execution and non-concurrent execution. The concurrent attribute of the loop node may be set according to requirements. When the concurrent attribute of the loop node is configured to be concurrent execution, as multiple secondary branches will be generated to concurrently execute the loop body, the execution efficiency and performance of the loop node may be improved.

Optionally, in the embodiments of the present disclosure, if the concurrent attribute of the loop node is configured to be concurrent execution, an execution result of the loop node is obtained according to execution result corresponding to each secondary branch.

During the above implementation, in a case where the concurrent attribute of the loop node is configured to be concurrent execution, an execution result of the loop node is obtained according to execution results corresponding to each secondary branch, so that corresponding rules may be set according to actual requirements, and the execution result corresponding to each secondary branch is mapped as the execution result of the loop node (For example, the execution results of each branch may be weighted, counted, and so on), so that the execution logic of the loop node can better express requirements of practical service.

Optionally, in the embodiments of the present disclosure, if the concurrent attribute of the loop node is configured to be concurrent execution, the loop ending condition includes: execution of each secondary branch is completed, an instruction that needs to end the loop early is executed in any one of the secondary branches, or execution of any one of the secondary branches times out; and after the execution of the loop node is completed, the generated secondary branches are destroyed, and the nodes in the service process continue to be executed using the branch to which the loop node belongs.

During the above implementation, there are many modes of ending the loop, so that execution logic of the loop node can better express requirements of practical service. When the execution of the loop node is completed, the generated secondary branches are timely destroyed, so as to release memory, CPU, network connection and other resources occupied by the branches, and continue to execute the nodes in the service process using the branch to which the loop node belongs, which may reduce consumption of system resources during the execution of the service process.

Optionally, in the embodiments of the present disclosure, generation rules of the branch identifier of the node include: if the node is not a child node of the loop node whose concurrent attribute is configured to be concurrent execution, the branch identifier of the node is consistent with the process instance identifier; and if the node is a child node of the loop node whose concurrent attribute is configured to be concurrent execution, the branch identifier of the node is generated according to the branch identifier of the loop node, which is closest to the node among parent nodes of the child node and whose concurrent attribute is configured to be concurrent execution, as well as a loop serial number corresponding to the node, wherein the loop serial number corresponding to the node is a serial number of current value of loop variable corresponding to the branch to which the node belongs in all values.

During the above implementation, the branch identifier corresponding to the node is generated according to the rules. Such branch identifier not only may identify the branch where the node is located, but also may reflect a parent relation between the nodes, so as to facilitate managing the nodes in the process.

Optionally, in the embodiments of the present disclosure, the service process includes a first node and a second node, wherein an execution order of the first node is before the second node; the node identifier, the process identifier and the branch identifier of the node are stored in association after execution of the node is completed; if parameters configured for the second node include reference to the execution result of the first node, a step of obtaining the execution result of the first node includes: acquiring the node identifier and the process instance identifier of the first node; querying nodes whose execution order is before the second node in the service process according to a reverse order of an execution order of the service process, with the second node as a starting point, and determining the branch identifier of each queried node according to the generation rules of the branch identifier and the branch identifier of the second node during the query; determining the branch identifier of the first node as the branch identifier of the queried node until the node identifier of the queried node is the node identifier of the first node; and acquiring the execution result of the first node stored in association with the node identifier, the process instance identifier and the branch identifier of the first node.

During the above implementation, the execution result of a preceding node (for example, the first node) may be acquired through the node identifier and the process instance identifier of the preceding node, as well as the generation rules of the branch identifier, so that a following node (for example, the second node) in the service process may refer to the execution result of the preceding node as input during the execution process, so that types of input of the nodes are enriched, and the execution logic of the nodes can better express requirements of practical service.

In the second aspect, embodiments of the present disclosure further provide a process orchestration apparatus, including: an orchestration module, configured to generate a to-be-orchestrated service process, in response to a node selection operation and a node parameter configuration operation based on an interface, wherein nodes supported for selection by the node selection operation include synchronous nodes and asynchronous nodes, wherein the synchronous nodes represent tasks which can be executed without waiting for an external action, and the asynchronous nodes represent tasks which need to wait for an external action to be executed; and an execution module, configured to execute the nodes in the service process successively according to an order of the nodes in the service process.

In the third aspect, embodiments of the present disclosure further provide an electronic device, including a processor and a memory, wherein the memory stores machine-readable instructions executable by the processor, and the machine-readable instructions, when executed by the processor, execute the method described above.

In the fourth aspect, embodiments of the present disclosure further provide a computer-readable storage medium, storing computer programs thereon, wherein the computer programs, when executed by the processor, execute the method described above.

With use of the process orchestration method, the process orchestration apparatus, the electronic device and the storage medium provided in the present disclosure, the to-be-orchestrated service process is generated through the node selection operation and the node parameter configuration operation, the visual programming is implemented, and the execution logic of the process can be visually represented and processed, which is more intuitive and understandable, and improves the speed of process development. Moreover, during the process orchestration, there is no need to write a large amount of codes, thus reducing the possibility of code syntax errors. Meanwhile, in the node selection operation, the nodes supported for selection include the synchronous nodes and the asynchronous nodes, and orchestration and execution of the synchronous nodes and/or the asynchronous nodes are implemented, thus effectively enhancing the compatibility and usability of the process orchestration engine. The problems that the application scope of the process orchestration engine is restricted and the process orchestration engine has poor usability are solved.

### BRIEF DESCRIPTION OF DRAWINGS

In order to more clearly illustrate technical solutions of embodiments of the present disclosure, drawings that need to be used in the embodiments of the present disclosure will be briefly introduced below. It should be understood that the following drawings only show some embodiments of the present disclosure, and therefore should not be regarded as limitation to the scope. Those ordinarily skilled in the art still could obtain other relevant drawings according to these drawings without using any inventive efforts.

FIG. 1 is a schematic flowchart of a process orchestration method provided in embodiments of the present disclosure;

FIG. 2 is a schematic diagram of a visual orchestration interface provided in embodiments of the present disclosure;

FIG. 3 is a schematic diagram of a node parameter configuration operation provided in embodiments of the present disclosure;

FIG. 4 is a schematic diagram of a loop node, with a concurrent attribute being configured to be concurrent execution, provided in embodiments of the present disclosure;

FIG. 5 is a schematic diagram of execution procedure of a loop node, with a concurrent attribute being configured to be non-concurrent execution, provided in embodiments of the present disclosure;

FIG. 6 is a schematic diagram of execution procedure of a loop node, with a concurrent attribute being configured to be concurrent execution, provided in embodiments of the present disclosure;

FIG. 7A and FIG. 7B are a schematic diagram of execution procedure of nested loop nodes provided in embodiments of the present disclosure;

FIG. 8 is a schematic diagram of referring to an execution result of a node provided in embodiments of the present disclosure;

FIG. 9 is a schematic diagram of a data table including interaction buttons provided in embodiments of the present disclosure;

FIG. 10 is a structural schematic diagram of a process orchestration apparatus provided in embodiments of the present disclosure; and

FIG. 11 is a structural schematic diagram of an electronic device provided in embodiments of the present disclosure.

### DETAILED DESCRIPTION OF EMBODIMENTS

Embodiments of technical solutions of the present disclosure will be described in detail below in conjunction with drawings. The following embodiments are only intended to describe the technical solutions of the present disclosure more clearly, and therefore they are only taken as examples, but cannot be used to limit the scope of protection of the present disclosure.

Unless otherwise defined, all technical and scientific terms used herein have the same meanings as those commonly understood by those skilled in the art to which the present disclosure belongs; the terms used herein are merely for the purpose of describing specific embodiments, but are not intended to limit the present disclosure.

In the description of the embodiments of the present disclosure, the technical terms such as “first” and “second” are merely used to distinguish different objects, but should not be construed as indicating or implying importance in the relativity or implicitly indicating the number, specific order or primary-secondary relation of related technical features. In the description of the embodiments of the present disclosure, “multiple (a plurality of)” refers to two and more, unless otherwise defined explicitly and specifically.

Before introducing the process orchestration method provided in the embodiments of the present application, some concepts involved in the embodiments of the present disclosure are introduced first:

Process orchestration generally refers to orchestration with use of several nodes to complete a certain service process, wherein each node represents one task that needs to be completed in the service process. During the orchestration, the nodes are organized in order, and aggregated into a specific execution chain, i.e., the service process. The nodes herein are, for example, IF (single branch judgment), IF-ELSE (double branch judgment), FOR (for loop), BREAK (exit loop), CONTINUE (end current loop), SWITCH (multi-branch selection), Function Call (function call, possibly for various functions), Create Variable (create variable), Set Variable (set variable), Return (return), and termination (terminate).

A process orchestration engine refers to software for supporting a process orchestration function. The process orchestration engine in the present disclosure may interact with a user via a visual interface, so as to respond to an orchestration operation executed by the user on the interface, and implement the process orchestration.

The inventors find from researches that the existing process orchestration engine only supports orchestration of synchronous tasks. The synchronous tasks are tasks that may be completed through automatic execution according to task logic, without waiting for an external action during the execution. However, tasks involved in a practical service process may include asynchronous tasks. The asynchronous tasks refer to tasks that need to wait for an external action to be executed. The current existing process orchestration engine does not yet support orchestration of asynchronous tasks, and thus cannot adapt to diversified orchestration requirements of the practical service process, and the process orchestration engine has poor compatibility and usability.

Embodiments of the present disclosure provide a process orchestration method, a process orchestration apparatus, an electronic device and a storage medium. A to-be-orchestrated service process is generated by a user executing a node selection operation and a node parameter configuration operation on an interface, thereby implementing visual process orchestration. Moreover, in the node selection operation, nodes supported for selection include synchronous nodes and asynchronous nodes, that is, in the service process, the synchronous nodes may be orchestrated to support synchronous tasks, and the asynchronous nodes may be orchestrated to support asynchronous tasks, so that the obtained service process may effectively describe diversified task types in a practical service, and thus the problem that the existing orchestration engine cannot adapt to the orchestration requirements of the practical service process is solved, and the compatibility and usability of the orchestration engine are improved.

It should be understood that, in addition to the technical solutions provided in the embodiments of the present disclosure, the above analysis of the technical problem existing in the existing process orchestration engine also belongs to the inventors' contributions to the present disclosure, rather than contents already existing in the prior art. With reference to FIG. 1, it shows a schematic flowchart of a process orchestration method provided in embodiments of the present disclosure. The process orchestration method provided in the embodiments of the present disclosure may be applied to an electronic device, wherein the electronic device is deployed with a process orchestration engine, and the process orchestration method may be executed by, but not limited to, the process orchestration engine. The electronic device may refer to a terminal and a server with a function of executing computer program, wherein the terminal specifically may be a smart phone, a tablet computer, a computer, a personal digital assistant (PDA), or the like; the server specifically may be an application server or a Web server. There may be one or more electronic devices, for example, a cluster consisting of multiple servers. The electronic device may be a physical device or a virtual device. The process orchestration method may include:

Step S110: generating by a process orchestration engine, a to-be-orchestrated service process, in response to a node selection operation and a node parameter configuration operation based on an interface, wherein nodes supported for selection by the node selection operation include synchronous nodes and asynchronous nodes, and wherein the synchronous nodes represent tasks which can be executed without waiting for an external action, and the asynchronous nodes represent tasks which need to wait for an external action to be executed.

The interface in step S110 refers to a visual orchestration interface for the user to perform the process orchestration, for example, a graphical user interface of application software and a Web page. The node selection operation refers to an operation of the user selecting, from the nodes supported for selection in the interface, a node in the to-be-orchestrated service process, and the node parameter configuration operation refers to an operation of the user performing parameter configuration on the selected node. Certainly, it is not excluded that the user may perform other operations related to the process orchestration on the interface.

The interface and the process orchestration engine are associated with each other, for example, the interface may be displayed on a terminal device (such as a smart phone or a computer) used by the user, and the process orchestration engine may be deployed on a background server. Certainly, a situation that the interface and the process orchestration engine are located on the same device is not excluded. Various process orchestration operations performed by the user on the interface may form corresponding operation data to be transmitted to the process orchestration engine, so that the process orchestration engine may perceive the operations performed by the user and respond.

Each node represents a task that the process orchestration engine supports to execute, and the user may select nodes according to requirements of a service process, so as to construct the service process. With regard to the node selection operation, nodes supporting user selection include two types: synchronous nodes and asynchronous nodes, while one service process does not necessarily contain both types of nodes, and may contain only one type of nodes. In the above, the synchronous nodes represent tasks that can be executed without waiting for an external action, that is, the synchronous tasks mentioned in the preceding, for example, a task of performing data statistics according to a configured formula; and for another example, a task of sending an email according to a configured recipient, and the like. The asynchronous nodes represent tasks that need to wait for an external action to be executed, that is, the asynchronous tasks mentioned in the preceding, for example, a task of filling in a form, wherein this task needs to wait for a specific user to fill in the form to be executed, and the user filling in the form herein is the so-called external action; for another example, a function calling back task, wherein this task needs to wait for a third party (which may refer to a certain software other than the process orchestration engine) to call back a target function to be executed, and the third party calling back the target function herein is the so-called external action. However, it needs to be indicated that an asynchronous task further may be divided into a plurality of links internally, wherein some links may be automatically executed, and some links need to wait for an external action to be executed, but viewing from the whole task, it is still considered that it needs to wait for an external action to be execuded, or in other words, it needs to wait for an external action to be executed completed.

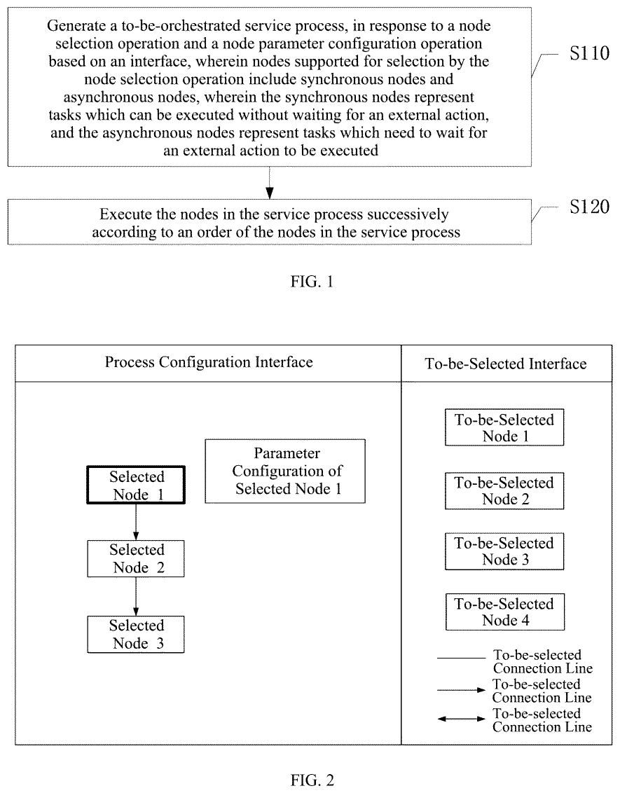

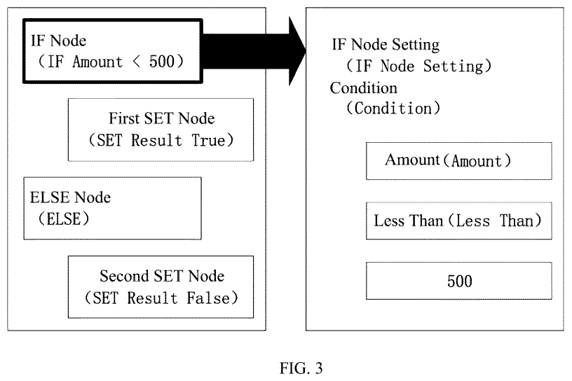

As an optional mode, FIG. 2 is a schematic diagram of a visual orchestration interface provided in embodiments of the present disclosure. Referring to FIG. 2, the visual orchestration interface may include a selection interface and a process configuration interface. The process configuration interface is used to display a service process currently having been orchestrated, and the selection interface is used to display nodes supported for selection, which may be referred to as to-be-selected nodes for short. As stated previously, the to-be-selected nodes may include two types: the synchronous nodes and the asynchronous nodes. For example, the node selection operation may be an operation of selecting a desired node from the to-be-selected nodes displayed on the selection interface and dragging the selected node to an appropriate position on the process configuration interface; or an operation of selecting a desired node on the selection interface in a clicking manner, wherein the clicked node will be automatically displayed at an appropriate position on the process configuration interface, and so on.

In the process configuration interface, the user also may connect nodes selected through the node selection operation by connection lines, so as to determine an execution order of the nodes; or in some implementations, the nodes also may be automatically connected (for example, when a certain node is clicked on, it will be automatically connected to a tail end of the service process).

Some nodes have configurable parameters, and these nodes need to be configured with appropriate parameters by the user to be correctly executed. It Certainly, it is not excluded that the process orchestration engine may specify default parameters for the nodes in a case where the user does not configure parameters. With reference to FIG. 3, it shows a schematic diagram of the node parameter configuration operation provided in embodiments of the present disclosure. IF node is a node that can be configured with parameters. The node parameter configuration operation is, for example, as follows: when the user hovers mouse over the IF node or clicks on the IF node, right interface pops up, and an input box is displayed on the interface so as to facilitate the user in configuring specific parameters of the IF node, for example, configuring conditions in the IF node (Amount Less Than 500 herein).

In some implementations, in addition to the node selection operation and the node parameter configuration operation, the user further may perform other orchestration operations on the interface, for example, node deletion operation. With continued reference to FIG. 3, when the mouse is hovered over an existing node (for example, First SET Node or Second SET Node) in the service process, deletion button further may be displayed, so that this node is deleted when the user clicks on the deletion button.

An orchestrated service process may be described inside the orchestration engine according to a certain syntax rule. For example, the nodes may be described by a set of several fields, and these fields also may have a nested relation therebetween. IF-ELSE node (the IF-ELSE node may be considered as a combination of IF node and ELSE node, and this node implements logic of if-else statement in structured programming) in FIG. 3 is taken as an example below to illustrate a possible way to describe the node inside the process orchestration engine. This node includes several fields, namely, id, type, nodeName, condition, subFlow, and elseSubFlow, wherein id is node identifier, type is node type, and nodeName is node name, Condition is condition configured for the node (for example, Amount Less Than 500), subFlow represents subflow to be executed if the condition is met, which may include fields corresponding to one or more nodes (for example, First SET Node), wherein these fields may be nested inside subFlow, and elseSubFlow represents subflow to be executed when the condition is not met, which may include fields corresponding to one or more nodes (for example, Second SET Node), wherein these fields may be nested inside elseSubFlow, and nodes in subFlow and elseSubFlow also may be called as child nodes of the IF-ELSE node.

The concept of child node is introduced in the above examples. Not only IF-ELSE node has child nodes, but also some other nodes, such as loop node to be described later, also have child nodes. If a node in a service process has no child node, it is easy to judge whether this node is a synchronous node or an asynchronous node. If a node has child nodes, it may be specified that if all the child nodes of this node are synchronous nodes, this node itself is also a synchronous node; and if the child nodes of this node contain an asynchronous node, this node itself is an asynchronous node.

Step S120: executing, by the process orchestration engine, the nodes in the service process successively according to an order of the nodes in the service process.

In step S120, after the user has orchestrated the service process, the user may send an execution-confirming instruction to the process orchestration engine by clicking an execution-confirming button on the interface. The process orchestration engine, upon receipt of the execution-confirming instruction, executes the nodes in the service process successively. Execution logics inside each node are implemented in advance by the process orchestration engine. It may be understood that the nodes may be executed automatically or triggered under certain conditions after the user has orchestrated the service process. Alternatively, it is also feasible that the orchestrated parts are executed automatically when the user orchestrates the service process.

The service process may be executed interpretively. However, in order to improve execution efficiency, the service process also may be translated into high-level computer language codes, and the execution of the process is realized by executing corresponding high-level computer language codes.

In the above, when a synchronous node in the service process is to be executed, corresponding synchronous task may be completed just by automatically executing the task directly according to an execution logic preset therefor by the process orchestration engine, and subsequent nodes (if any) in the service process continue to be executed. When an asynchronous node in the service process is to be executed, the execution of the service process will be blocked (possibly only one branch is blocked. See definition of branch hereinafter for details), the external action needs to be waited for to complete the corresponding asynchronous task, and subsequent nodes (if any) in the service process continue to be executed. Herein, a subject performing the external action may be a person, certain third-party software, or a certain device.

Whether to execute the external action may be perceived for the process orchestration engine. For example, if the user clicks on a form submission button on the interface after filling in a form, form data will be returned to the process orchestration engine, so that the process orchestration engine may perceive that the user has completed an action of submitting the form data. After the third party calls back the target function, if the target function belongs to a part of the process orchestration engine or is monitored by the process orchestration engine, the process orchestration engine also may perceive that the third party has completed an action of calling back the function, and so on.

If the external action is not executed for a long time, the process will be continuously blocked at the asynchronous node, causing it unable to execute all the subsequent nodes. With regard to this problem, a timeout handling mechanism further may be set for the asynchronous nodes. If the process orchestration engine does not perceive the execution of the external action within a preset cycle period, a timeout handling instruction may be executed, for example, an execution result is mandatorily designated to the asynchronous node, and subsequent nodes continue to be executed, or the execution of the process is mandatorily terminated, and the like. In the above, the preset cycle period may be configured inside the process orchestration engine, or may be configured by the user as a parameter of the asynchronous node. In addition, it should be noted that the external action is directed to an execution stage of the service process, and the node parameter configuration operation performed in an orchestration stage of the service process does not belong to external actions.

During the above implementation, the to-be-orchestrated service process is generated by the user executing the node selection operation and the node parameter configuration operation on the interface, thereby implementing the visual process orchestration. Such orchestration does not require writing a large amount of codes, so that the efficiency of process orchestration is improved, the probability of code syntax errors is reduced, and thus the service process orchestration is more intuitive and friendly to operate for ordinary users.

Meanwhile, in the node selection operation, the nodes supported for selection include the synchronous nodes and the asynchronous nodes, that is, in the service process, the synchronous nodes may be orchestrated to implement tasks which can be executed without waiting for the external action, and the asynchronous nodes also may be orchestrated to implement tasks which need to wait for the external action to be executed (the two types of nodes definitely also may be orchestrated simultaneously), so that the obtained service process may effectively describe diversified task types in practical service, and thus the problem that the existing orchestration engine cannot adapt to the orchestration requirement of the practical service process is solved, and the compatibility and usability of the orchestration engine are improved.

Optionally, in the embodiments of the present disclosure, attributes of the nodes include node identifier, process instance identifier and branch identifier. These identifiers may be automatically allocated by the process orchestration engine, and that these identifiers may be configured by the user (regarded as parameters of the nodes) is not excluded.

In the above, the node identifier, a unique identifier of a node, is used to identify different nodes in the service process, and further may be referred to in the service process. The node identifier may be represented by Node ID.

Each time the service process runs, one process instance is generated. If the service process is considered as a template, the process instance may be considered as a real object created based on this template. The service process does not contain actual data, while the process instance contains actual data. The process instance identifier is used to identify the process instance to which nodes belong. Herein, as the process instance is an instantiation result of the service process, the process instance also contains all the nodes in the service process.

In the same run of the same service process, process instance identifiers of all nodes in the service process are consistent, while in different runs of the same service process, even the same node has different process instance identifiers. For example, in a first run (or a second run) of one service process, the process instance identifiers of all nodes in the service process are the same, but the process instance identifiers generated in the first run and the second run of the service process are different. Therefore, the nodes in different process instances may be distinguished and identified according to the process instance identifiers. The process instance identifiers may be represented by Flow Instance ID.

The process instance includes one or more branches. The branch is a concurrent execution branch in the process instance, and the branch may be corresponding to one fragment containing several nodes in the service process (for example, it may be seen from following contents that the branch may be corresponding to a loop body of a loop node). Specifically, if a process instance includes only one branch, this branch may be considered as the process instance per se, or the process instance may be considered as having no branch in this case. Branches included in a process instance further may be of a hierarchical structure, that is, some branches may be subordinate to other branches rather than directly subordinate to the process instance. For example, a certain process instance contains three branches, wherein a first branch further contains two secondary branches, and from a general view, all the five branches may be regarded as branches contained in the process instance. The branch identifier is used to identify a branch to which a node belongs. In the service process, the branch identifiers corresponding to nodes of the same branch are the same. The branch identifier may be represented by Thread ID.

During the above implementation, by introducing the branches to the process instance, the execution efficiency of the process is improved (because the branches may be executed in parallel). Meanwhile, by respectively setting the attributes of the nodes, such as the node identifier, the process instance identifier and the branch identifier, different entities (nodes, process instances, and branches) involved in the execution of service process are distinguished, which is conducive to ensuring the accuracy and reliability of the process execution. As to how to specifically use these attributes of the nodes, examples later are referred to for details.

Optionally, in the embodiments of the present disclosure, the nodes in the service process include the loop node. The loop node is a node that requires repeated execution of the loop body until a loop ending condition is met. The loop body is a process fragment that requires repeated execution defined inside the loop node. The loop body may contain one or more nodes, and these nodes may be called as child nodes of the loop node. The child nodes in the loop body define operations or logics to be executed by the loop node, and particularly, the child nodes of the loop node also may be loop nodes.

A loop node may be a synchronous node, or an asynchronous node: if all loop nodes in the loop body are synchronous nodes, the loop node also may be considered as a synchronous node; if the loop body of the loop node contains an asynchronous node, the loop node may be considered as an asynchronous node.

Parameters of the loop node include concurrent attribute, and the concurrent attribute of the loop node may be configured to be concurrent execution and non-concurrent execution.

When a loop node is to be executed in step S120, if the concurrent attribute of the loop node is configured to be concurrent execution, the process orchestration engine generates secondary branches, whose number is the same as a total number of values of a loop variable of the loop node, under a branch to which the loop node belongs (in this case, the process instance is also considered as one branch), and concurrently executes the loop body under each value of the loop variable using the secondary branches, wherein each secondary branch is used to execute the loop body under one value of the loop variable.

When a loop node is to be executed in step S120, if the concurrent attribute of the loop node is configured to be non-concurrent execution, the loop body is repeatedly executed according to change of the loop variable using the branch to which the loop node belongs, that is, the loop body is serially executed according to loop logic.

Correspondingly, the nodes in the service process further may include non-loop nodes. The non-loop nodes may be defined as nodes that do not require repeated execution of the loop body. Since repeated execution is not involved, the non-loop nodes generally may be executed serially.

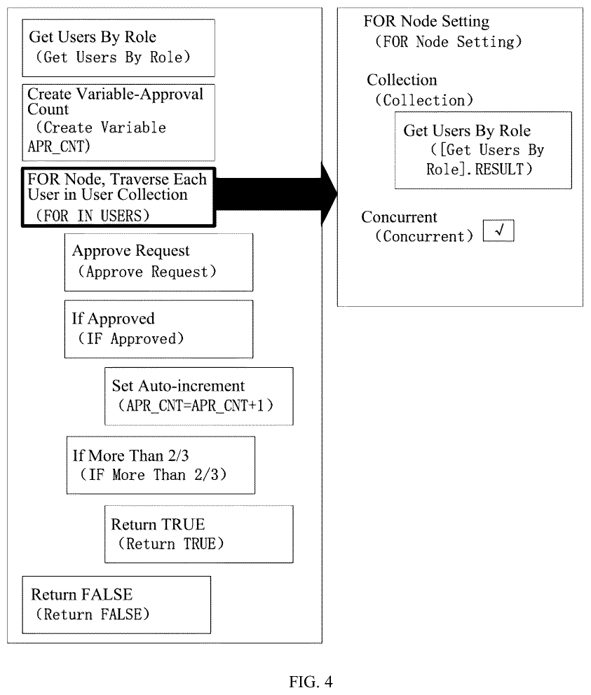

With reference to FIG. 4, it shows a schematic diagram of the loop node, with the concurrent attribute being configured to be concurrent execution, provided in embodiments of the present disclosure.

An asynchronous node, FOR node, is a loop node (the FOR node implements logic of for statement in structured programming). The loop body is a part from Approve Request node to Return TRUE node, and the concurrent attribute of this loop node is configured to be concurrent execution. A method of configuring the parameter of concurrent attribute may be checking Concurrent option, and other methods certainly are not excluded. For example, one form needs to be examined and approved by multiple approvers, who are USER1, USER2 and USER3, and then the three approvers USER1, USER2 and USER3 are three values that may be taken for loop variable USERS of the loop node. When the loop node is to be executed, the process orchestration engine generates three secondary branches under the branch to which the loop node belongs, and concurrently executes the loop body when USER1, USER2 and USER3 are respectively taken for the loop variable using the three secondary branches.

If the concurrent attribute of the loop node in FIG. 4 is configured to be non-concurrent execution, that is, Concurrent option is not checked, the process orchestration engine will not generate the secondary branches for the branch to which the loop node belongs, and the branch to which the loop node belongs executes the loop body successively when USER1, USER2 and USER3 are respectively taken for the loop variable.

The loop node is illustrated in the above example through the FOR node. However, in the structured programming, not only for statement may implement a loop, while statement, for example, also may implement a loop, and therefore in some implementations, the loop node also may include WHILE node, which may be analyzed similar to the FOR node.

As mentioned in the preceding, the process instance may include one or more branches that may be generated in execution by the loop node whose concurrent attribute is configured to be concurrent execution.

The execution procedure of loop nodes with two concurrent attributes is described below with schematic diagrams.

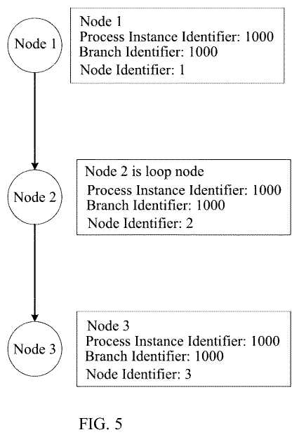

With reference to FIG. 5, it shows a schematic diagram of execution of a loop node, with the concurrent attribute being configured to be non-concurrent execution, provided in embodiments of the present disclosure.

The service process in FIG. 5 includes nodes 1˜3, wherein node 2 is a loop node, and the concurrent attribute is configured to be non-concurrent execution, values of loop variable i in the node 2 are i=1, i=2 and i=3, and a branch to which the node 2 belongs is 1000 (it means that the branch identifier is 1000), and then when the node 2 is to be executed, the process orchestration engine executes the loop body (the loop body is not shown in the drawing) when i=1, i=2 and i=3 successively using the branch 1000 to which the node 2 belongs. Note that since the node 2 does not generate a branch in this case, the branch 1000 to which the node 2 belongs may be considered as the process instance per se. It may be seen without difficulty that, if the concurrent attribute of the loop node is configured to be non-concurrent execution, the loop node has no difference from the non-loop node in execution, that is, both are serially executed.

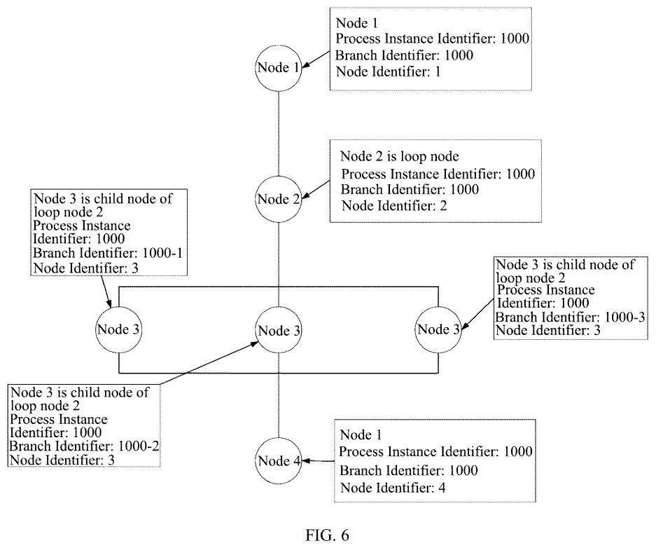

With reference to FIG. 6, it shows a schematic diagram of execution of a loop node, with the concurrent attribute being configured to be concurrent execution, provided in embodiments of the present disclosure.

The service process in FIG. 6 includes nodes 1˜4, wherein node 2 is a loop node, whose concurrent attribute is configured to be non-concurrent execution. The loop body of the node 2 includes nodes 3, values of loop variable i in the loop node are i=1, i=2 and i=3, that is, a total number of values taken for the loop variable is 3, so that three secondary branches are generated under the branch to which the node 2 belongs. If the branch to which the loop node belongs is represented by 1000, the three secondary branches may be 1000-1, 1000-2 and 1000-3, respectively. The loop body of the node 2 when i=1 is executed using the secondary branch 1000-1; the loop body of the node 2 when i=2 is executed using the secondary branch 1000-2; the loop body of the node 2 when i=3 is executed using the secondary branch 1000-3; and an execution mode is that the three secondary branches concurrently execute corresponding loop body.

During the above implementation, the nodes in the service process include the loop node, and the concurrent attribute of the loop node may be configured to be concurrent execution and non-concurrent execution. The concurrent attribute of the loop node may be set according to requirements. When the concurrent attribute of the loop node is configured to be concurrent execution, as multiple secondary branches will be generated to concurrently execute the loop body, the execution efficiency and performance of the loop node may be improved.

Optionally, in the embodiments of the present disclosure, if the concurrent attribute of the loop node is configured to be concurrent execution, an execution result of the loop node is obtained according to execution result corresponding to each secondary branch. In specific implementation, corresponding rules may be set according to actual requirements, and the execution result corresponding to each secondary branch is mapped as the execution result of the loop node. For example, the execution result of each branch may be weighted, counted, and so on, so that the execution logic of the loop node can better express requirements of practical service.

With continued reference to FIG. 4, following the above embodiments, the approvers are USER1, USER2 and USER3, respectively, and three secondary branches execute the loop body corresponding to USER1, USER2 and USER3, respectively, so as to obtain the execution result corresponding to each secondary branch, that is, examination and approval results of the three approvers. The execution result of the loop node may be determined according to the examination and approval results of the three approvers and a preset condition, for example, the preset condition is that if the number of approvers who approves it is greater than a preset threshold (for example, two thirds), it is considered that the execution result of the loop node is Approved; if the number of approvers who approves it is not greater than the preset threshold, it is considered that the execution result of the loop node is Rejected.

Optionally, in the embodiments of the present disclosure, if the concurrent attribute of the loop node is configured to be concurrent execution, the loop ending condition includes: (1) execution of each secondary branch is completed, (2) an instruction that needs to end the loop early is executed by any one of the secondary branches, or (3) execution of any one of the secondary branches times out; and after the execution of the loop node is completed, the generated secondary branches is destroyed, and the nodes in the service process continue to be executed using the branch to which the loop node belongs.
Regarding condition (1), for example, with respect to FIG. 4, that the three secondary branches all return the examination and approval results of corresponding approvers means that the execution of the three secondary branches is completed.
Regarding condition (2), for any one of the secondary branches, when an instruction that needs to end the loop early, such as break instruction, is to be executed, the current loop will be immediately terminated, wherein these instructions may be corresponding to particular nodes during the orchestration.
Regarding condition (3), execution timeout of any one of the secondary branches means that execution time of any one of the secondary branches exceeds a preset cycle period. The condition (3) is mainly used for cases where the loop body contains the asynchronous node (because the external action corresponding to the asynchronous node easily causes timeout), but also may be directed to the loop body only containing the synchronous node. In the above, the preset cycle period may be configured inside the process orchestration engine, or may be configured by the user as a parameter of the loop node.

When the loop ending condition is met, it is considered that the execution of the loop node is completed, and in this case, the generated secondary branches under the branch to which the loop node belongs are destroyed, so as to release resources occupied by the secondary branches, and continue to execute the nodes in the service process using the branch to which the loop node belongs. For example, referring to FIG. 6, after execution of the node 2 is completed, the secondary branches 1000-1, 1000-2, and 1000-3 are all destroyed, the branch currently being executed is changed to 1000 again, and nodes 4 continue to be executed using the branch 1000. Certainly, if there is no other node after the loop node, the execution of the service process also may be ended. In addition, if some special instructions, for example, termination instruction, are encountered in the loop body, the execution of the service process also may be directly terminated, rather than continuing to execute the nodes after the loop node.

During the above implementation, there are many modes of ending the loop, so that execution logic of the loop node can better express requirements of practical service. When the execution of the loop node is completed, the generated secondary branches are timely destroyed, so as to release memory, CPU, network connection and other resources occupied by the branches, and continue to execute the nodes in the service process using the branch to which the loop node belongs, which may reduce consumption of system resources during the execution of the service process.

Optionally, in the embodiments of the present disclosure, generation rules of the branch identifier of the node in the service process include: if the node is not a child node of the loop node whose concurrent attribute is configured to be concurrent execution, the branch identifier of the node is consistent with the process instance identifier; if the node is a child node of the loop node whose concurrent attribute is configured to be concurrent execution, the branch identifier of the node is generated according to the branch identifier of the loop node, which is closest to the node among parent nodes of the child node and whose concurrent attribute is configured to be concurrent execution, as well as a loop serial number corresponding to the node, wherein the loop serial number corresponding to the node is a serial number of current value of loop variable corresponding to the branch to which the node belongs in all values.

Firstly, definition of the child node is explained herein: all nodes subordinate to a node are called as child nodes thereof, regardless of whether the nodes are directly subordinate. For example, a loop body of a loop node A contains three nodes, and the three nodes are all child nodes of the loop node. Further, assuming that a certain node among the three nodes is also a loop node marked as loop node B, and the loop node B contains four child nodes, although the four child nodes are not direct subordinates of the loop node A, they also may be considered as child nodes of the loop node A. Correspondingly, any child node of the loop node A may call the loop node A as its own parent node.

Since only the loop node whose concurrent attribute is configured to be concurrent execution will generate new branches, if one node is not a child node of any loop node whose concurrent attribute is configured to be concurrent execution, it is still in a major branch of the process instance rather than a certain secondary branch generated during the run of the process instance; therefore, the branch identifier of the node may be set to be consistent with the process instance identifier.

With continued reference to FIG. 6, none of the nodes 1, 2, and 4 is a child node of a loop node whose concurrent attribute is configured to be concurrent execution, and thus their branch identifiers are all the same as the process instance identifier, which is 1000.

If the concurrent attribute of the loop node is configured to be concurrent execution, the branch identifier of child nodes directly subordinate to this loop node may be generated according to the branch identifier of this loop node as well as the loop serial number corresponding to the child nodes. If a certain child node directly subordinate to this loop node is also a loop node, and the concurrent attribute is also configured to be concurrent execution, the branch identifier of the child nodes directly subordinate to this child node also may be deduced similarly. If a certain direct subordinate child node of this loop node is also a loop node, but the concurrent attribute is configured to be non-concurrent execution, or is a non-loop node, the branch identifier of the direct subordinate child nodes of this child node is consistent with the branch identifier of this child node. By analogy, the branch identifier of each node in the service process may be obtained.

This procedure may be briefly summarized as follows: in a path from a certain upper node to a certain lower child node, if a loop node whose concurrent attribute is configured to be concurrent execution is encountered, a new branch identifier needs to be derived for the child nodes of this loop node; otherwise, the current branch identifier remains unchanged.

Accordingly, if one node is a child node of a certain loop node or some loop nodes whose concurrent attribute is configured to be concurrent execution, backtracking may be performed upwards layer by layer from a direct parent node of this node. According to the preceding definition of child node, all nodes on a backtracking path may be called as parent nodes of this node. Among these parent nodes, a loop node which is closest to this node and whose concurrent attribute is configured to be concurrent execution is just the loop node for deducing the branch identifier of this node.

With continued reference to FIG. 6, the node 2 is a loop node, and the concurrent attribute of this loop node is configured to be concurrent execution, wherein the nodes 3 are child nodes in the loop body of the node 2. The node 3 in a first branch (leftmost branch) is taken as an example below to explain the generation rules of the branch identifier: among the parent nodes of the node 3 in the first branch, the loop node closest to the node 3 in the first branch is the node 2, and the node 2 is a loop node whose concurrent attribute is configured to be concurrent execution, and thus the branch identifier 1000 of the node 2 is obtained; then the loop serial number of the node 3 in the first branch is acquired: the loop serial number corresponding to the node 3 in the first branch is the serial number of current value of the loop variable corresponding to the branch to which this node belongs in all values, for example, the current value of the loop variable is 2, and all the values include 2, 4 and 6; and then the serial number of the current value of the loop variable in all the values may be 1.

After the branch identifier 1000 of the node 2 and the loop serial number 1 corresponding to the node 3 in the first branch are acquired, the branch identifier of the branch node 3 in the first branch is generated according to the branch identifier of the node 2 and the loop serial number corresponding to the node 3 in the first branch. For example, the branch identifier 1000 of the node 2 and the loop serial number 1 corresponding to the branch node 3 in the first branch may be spliced, so as to generate the branch identifier of the node 3 in the first branch, for example, they are spliced by horizontal line connection in FIG. 6 to obtain the branch identifier 1000-1. The branch identifier of the node 2 and the loop serial number corresponding to the node 3 in the first branch also may be subjected to a preset operation to obtain the branch identifier of the node 3 in the first branch.

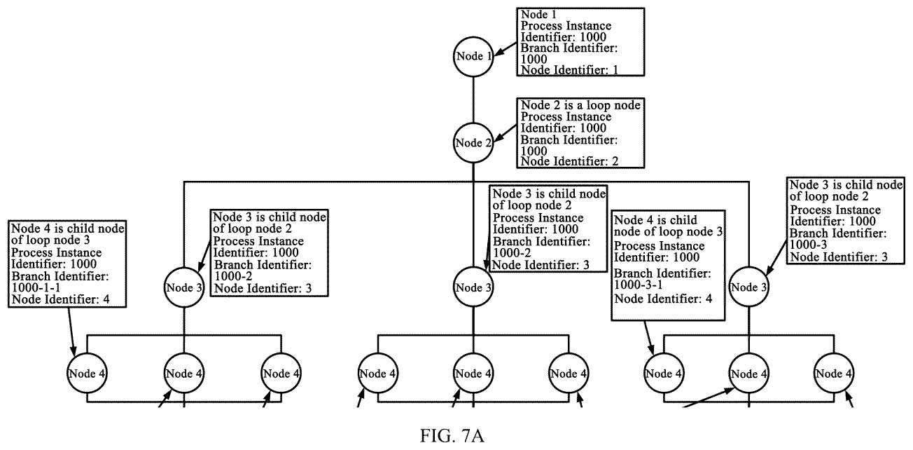

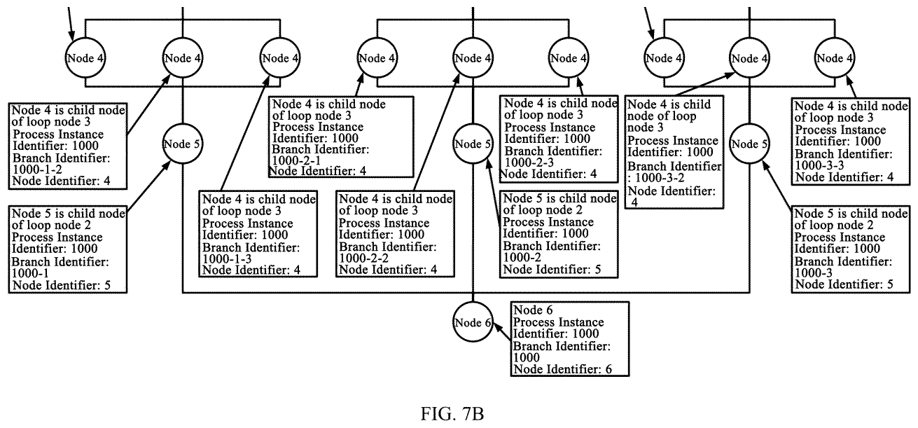

With reference to FIG. 7A and FIG. 7B, it shows a schematic diagram of execution of nested loop nodes provided in embodiments of the present disclosure.

As described in the preceding, the child nodes of the loop node refer to all nodes in the loop body corresponding to the loop node. In an optional embodiment, the child nodes of the loop node further may include loop nodes. As shown in FIG. 7A and FIG. 7B, the child nodes of the loop node 2 include nodes 3, nodes 4 and nodes 5, wherein the nodes 3 are also loop nodes, child nodes of the nodes 3 include the nodes 4, and the concurrent attributes of the node 2 and the nodes 3 are both configured to be concurrent execution.

The node 4 in a first branch (leftmost branch) is taken as an example below to explain the generation rules of the branch identifier: the node 4 in the first branch is the leftmost node 4. Firstly, parent nodes of the node 4 in the first branch are determined, including the node 3 in the first branch and the node 2. Since the node 4 in the first branch has many parent nodes, the parent node closest to the node 4 in the first branch further needs to be determined from the parent nodes, which is the node 3 in the first branch, and the branch identifier 1000-1 of the node 3 in the first branch is acquired. Then the loop serial number 1 of the node 4 in the first branch is acquired. The branch identifier of the node 4 in the first branch may be generated according to the branch identifier 1000-1 of the node 3 in the first branch and the loop serial number 1 of the node 4 in the first branch, for example, 1000-1-1. As to how to obtain the branch identifier of the node 3 in the first branch, reference may be made to the foregoing description of FIG. 6. When actually executing the service process, the branch identifier of the node may be determined when this node is to be executed, while when the node 4 in the first branch is to be executed, the node 3 in the first branch obviously has been executed, and thus in this case, the branch identifier of the node 3 in the first branch is known.

During the above implementation, the branch identifier corresponding to the node is generated according to the rules. Such branch identifier not only may identify the branch where the node is located, but also may reflect a parent relation between the nodes, so as to facilitate managing the nodes in the process. For example, in FIG. 6, in combination with the generation rules of the branch identifier, according to the branch identifier 1000-1 of the node 3 and the branch identifier 1000 of the node 2, it may be learned that the node 3 is a child node of the node 2 and belongs to the first branch generated by the node 2.

In the service process, each node generally includes input and output, and the output of the node is generally the execution result of the node. In the service process, the node later in the execution order may refer to the execution result of the node earlier in the execution order as the input thereof. A first node and a second node are taken as an example to explain how to parse the reference to the execution result of the node. It is assumed that the service process includes the first node and the second node, wherein the execution order of the first node is before the second node. Apparently, the first node and the second node are merely used in a general sense, and do not represent two specific nodes.

Optionally, in the embodiments of the present disclosure, each time one node is executed, the node identifier, the process instance identifier, and the branch identifier of this node are stored in associated with the execution result of this node after the execution of the node is completed, for example, may be stored in a database for subsequent reading and use.

If the parameters configured for the second node include reference to the execution result of the first node, a step of obtaining the execution result of the first node includes: acquiring the node identifier and the process instance identifier of the first node; querying nodes whose execution order are before the second node in the service process according to a reverse order of an execution order of the service process, with the second node as a starting point, and determining the branch identifier of each queried node according to the generation rules of the branch identifier and the branch identifier of the second node during the query; determining the branch identifier of the first node as the branch identifier of the queried node until the node identifier of the queried node is the node identifier of the first node; and acquiring the execution result of the first node stored in association with the node identifier, the process instance identifier and the branch identifier of the first node (when the second node is to be execute, the first node obviously has been executed, and the execution result thereof is stored).

In the above, the parameter configured for the second node may be regarded as input of the second node, and that the parameter includes reference to the execution result of the first node means that (all or a part of) the execution result of the first node is taken as a value of the parameter configured for the second node. For example, the task corresponding to the first node is acquiring email address of user, and the execution result thereof is the acquired email address of user; the task corresponding to the second node is sending email to the above user, and therefore, when configuring the parameter of the second node, the execution result of the first node needs to be referred to, because the email address must be known to send email. When executing the second node, the process orchestration engine may parse the reference so as to acquire the execution result of the first node, and then assign the execution result of the first node to the second node, further completing the task of sending email to the user corresponding to the second node.

With reference to FIG. 8, it shows a schematic diagram of reference to the execution result of the node provided in embodiments of the present disclosure. As shown in FIG. 8, the above method of referring to the execution result of the first node includes making reference based on the node identifier of the first node and a preset reference symbol, such as $1. Email Address on the right of FIG. 8, wherein “$” is the reference symbol, 1 is the node identifier of the first node, $1 represents the execution result of the first node, and Email Address represents a specific data item (other data items are not excluded) in the execution result.

The step of obtaining the execution result of the first node is described below.

Firstly, the node identifier and the process instance identifier of the first node whose execution result needs to be referred to are acquired. If the first node and the second node are in the same process instance, the process instance identifier of the first node is consistent with the process instance identifier of the second node, and since the second node needs to refer to the execution result of the first node, the node identifier of the first node obviously is known, otherwise it cannot be configured into the parameters of the second node.

Then, the nodes whose execution order are before the second node in the service process are queried according to a reverse order of the execution order of the service process, with the second node as a starting point. The query aims at determining the branch identifier of the first node according to the generation rules of the branch identifier and the branch identifier of the second node. The query procedure may be understood in combination with examples later. Further, according to the node identifier, the process instance identifier and the branch identifier of the first node, the execution result of the first node stored in advance in association is read.

Exemplarily, as shown in FIG. 7A and FIG. 7B, the nodes 4 are used as second nodes, the node 2 is used as the first node, and the parameter configuration of the nodes 4 needs to refer to the execution result of the node 2. There are nine nodes 4 in total in FIG. 7A and FIG. 7B. For simplicity, the leftmost node 4 is only taken as an example. This node 4 has the node identifier 4, the branch identifier 1000-1-1, and the process instance identifier 1000. The node 2 has the node identifier 2 and the process instance identifier 1000, and the branch identifier currently is unknown, because when the node 4 is to be executed, a position of the node 2 in the service process is unknown.

For sequentially querying nodes whose execution order are before the node 4 in the service process, the leftmost node 3 may be queried first, and it is queried that the node 3 is a loop node whose concurrent attribute is configured to be concurrent execution, and is a direct parent node of the node 4. According to the generation rules of the branch identifier, the branch identifier 1000-1 of the node 3 may be reversely deduced using the branch identifier 1000-1-1 of the node 4; and it is queried that the node identifier of the node 3 is 3, the node identifier to be referred to is 2, and therefore, the node 3 is not the first node to be referred to.

It should be noted herein that, although there are three nodes 3 in FIG. 7A, for the leftmost node 4 in FIG. 7B, only the leftmost node 3 is queried, but the two nodes 3 on the right will not be queried. In other words, if the leftmost node 4 refers to the execution result of the node 3, only the execution result of the leftmost node 3 is referred to.

The query is continued according to the reverse order of the execution order of the service process. The queried node is the node 2, and it is queried that the node 2 is a loop node whose concurrent attribute is configured to be concurrent execution, and is a direct parent node of the node 3. According to the generation rules of the branch identifier, the branch identifier 1000 of the node 2 may be reversely deduced using the branch identifier 1000-1 of the node 3 (or using the branch identifier 1000-1-1 of the node 4). It is queried that the node identifier of the node 2 is 2, and the node identifier to be referred to is also 2; therefore, the node 2 is just the first node to be referred to. Thus, the branch identifier of the first node may be determined as the branch identifier of the queried node, which is 1000.

After it is determined through the above steps that the first node has the branch identifier 1000, the node identifier 2 and the process instance identifier 1000, the execution result of the first node stored in association with the node identifier, the process instance identifier and the branch identifier of the first node is acquired, and further the second node is executed.

It may be understood that, when it is queried that the node identifier of the node queried above is the node identifier of the first node, the query may be stopped, and there is no need to continue querying the nodes in the reverse order.

In an optional embodiment, by defining a variable, the execution result of the first node also may be stored using the variable. A scope of the variable may be entire process, and also may be nodes whose execution order are after the first node, so that the variable stored in the execution result of the first node may be accessed at the second node. With continued reference to FIG. 8, a variable-setting node may be inserted between the first node and the second node, and a variable is created by executing this node, wherein name of the variable is “Email Address”, and a variable value is the email address in the execution result of the first node.

When configuring the parameters of the second node, reference to the variable may be included, for example, the name (or other reference syntax) of this variable may be directly filled in, and the process orchestration engine may obtain the value of the variable by parsing the reference of the variable, thereby achieving an effect equivalent to that of directly referring to the execution result of the first node. With continued reference to FIG. 8, for example, for the second node, #Email Address may be filled in at recipient column, wherein “#” is a reference symbol, indicating that a variable name follows, so that the process orchestration engine may find the previously defined variable according to the variable name “Email Address”, acquire the value of the variable as value of recipient parameter of the second node, and execute the email sending task corresponding to the second node based on this value.

During the above implementation, the execution result of a preceding node (for example, the first node) may be acquired through the node identifier and the process instance identifier of the preceding node, as well as the generation rules of the branch identifier, so that a following node (for example, the second node) in the service process may refer to the execution result of the preceding node as input during the execution process, so that types of input of the nodes are enriched, and the execution logic of the nodes can better express requirements of practical service.

Optionally, in addition to referring to the execution result of the preceding node, the child node of the loop node also may refer to the loop variable. For a referring method, reference may be made to the reference to the execution result or variable in the above, which is not repeated.

Optionally, in the embodiments of the present disclosure, if the external action corresponding to the asynchronous node is an action of the user submitting data on a target page, the step of executing the asynchronous node in step S120 includes: obtaining the node identifier, the process instance identifier and the branch identifier of the asynchronous node; splicing the node identifier, the process instance identifier and the branch identifier of the asynchronous node, so as to generate an address of the target page; notifying the user executing the external action corresponding to the asynchronous node of the address of the target page in a preset method; and receiving data submitted by the user on the target page, wherein the data includes service data, and the node identifier, the process instance identifier and the branch identifier of the asynchronous node.

After obtaining the data submitted by the user, the process orchestration engine may continue to execute nodes (if any) after the asynchronous node in the service process. Alternatively, if the asynchronous node is provided with a timeout mechanism, the process orchestration engine also may mandatorily execute subsequent nodes after the execution of the asynchronous node times out.

Steps of executing the asynchronous node are described in detail below. Firstly, the process orchestration engine obtains the node identifier, the process instance identifier and the branch identifier of the asynchronous node. Since the execution of each node is completely under the control of the process orchestration engine, the attributes of each node may be obtained by the process orchestration engine.

The process orchestration engine then splices the node identifier, the process instance identifier and the branch identifier of the asynchronous node according to a preset rule, so as to generate the address of the target page. It should be noted that, in addition to the node identifier, the process instance identifier and the branch identifier of the asynchronous node, the address of the target page further may include other information, such as protocol used to access web page, IP address and page storage path. The address of the target page refers to a unique identifier for identifying and locating a web page, for example, it may be URL (Uniform Resource Locator) of the target page.

Next, the process orchestration engine notifies the user executing the external action corresponding to the asynchronous node of the address of the target page in a preset method, for example, the external action corresponding to the asynchronous node is that user A needs to fill in information items in a personal information filling page and submit the filled-in personal information, wherein the personal information filling page herein is a target page. After the address of the target page is acquired, the address of the target page may be notified to the user A by acquiring information of the user A, sending information to the user A, adding a to-do item of the user A, or the like.

The user A, after receiving the address of the target page through a terminal device he uses, clicks on the address of the target page, opens the target page, fills in personal information in the target page, and then submits data on the target page. The data will be submitted to the process orchestration engine. Contents of the data include the service data, and the node identifier, the process instance identifier and the branch identifier of the asynchronous node. In the above, the service data is the personal information filled in by the user A in the target page, and the node identifier, the process instance identifier and the branch identifier are carried in the address of the target page, so that the user A may not perceive the submission of the three items of data. It may be understood that, in different service scenarios, the service data further may be other data, such as submitted examination and approval results and examination and approval opinions after the user reviews the contents on the target page.

During the above implementation, the node identifier, the process instance identifier and the branch identifier of the asynchronous node are spliced, so as to generate the address of the target page, and notify the user of the address of the target page, so that the user, when submitting the data on the target page, may submit the node identifier, the process instance identifier and the branch identifier of the asynchronous node together. A branch under the process instance to which the asynchronous node belongs may be located through these identifiers, so as to continue to execute the nodes after the asynchronous node. That is, through the above implementation, the asynchronous node is supported at an execution level (the node selection operation has already achieved support to the asynchronous node at an interface level), thereby effectively enhancing the compatibility and usability of the process orchestration engine.

Optionally, in the embodiments of the present disclosure, a node pointer is provided for each branch in each process instance, and the pointer points to a node currently executed in the branch. After the data submitted by the user on the target page is received, the method further includes: obtaining the node identifier, the process instance identifier and the branch identifier of the asynchronous node from the data submitted by the user; determining a target node pointer based on the process instance identifier and the branch identifier, wherein the target node pointer refers to the node pointer corresponding to the process instance and the branch to which the asynchronous node belongs; and if the node identifier of the asynchronous node is consistent with the node identifier of the node to which the target node pointer points, continuing to execute nodes after the asynchronous node in the service process.

The process orchestration engine sets a node pointer for each branch in the process instance (the process instance itself is also regarded as a branch). The node pointer points to the node currently executed in the branch. Each time one node is executed, a value of the node pointer is updated therewith, and it points to the next node in the branch, and the process orchestration engine also will continue to execute the next node. If the branch is destroyed, the corresponding node pointer also may be released together.

In the execution steps of the asynchronous node, after the user submits data on the target page, the process orchestration engine may determine the target node pointer based on the process instance identifier and the branch identifier in the data submitted by the user. The target node pointer refers to a node pointer corresponding to the process instance and the branch to which the asynchronous node belongs. The process instance to which the asynchronous node belongs is determined according to the process instance identifier submitted by the user, while the branch to which the asynchronous node belongs is determined according to the branch identifier submitted by the user. The target node pointer points to the node currently executed in the branch to which the target node pointer belongs.

If the node identifier of the asynchronous node is consistent with the node identifier of the node to which the target node pointer points, it indicates that before the branch to which the target node pointer belongs, the position of the asynchronous node is just to be executed, and after that the execution process is suspended, and is waiting for the user to submit data. The data submitted by the user is just the data corresponding to the external action waited for by the asynchronous node, so that the process orchestration engine may continue to execute the nodes after the asynchronous node in the service process. If the node identifier of the asynchronous node is inconsistent with the node identifier of the node to which the target node pointer points, an exception may be thrown.

During the above implementation, the node pointer points to the node currently executed in the branch, the target node pointer is determined using the process instance identifier and the branch identifier in the data submitted by the user, and whether execution is continued is judged by comparing the node identifiers, so as to control and manage forwarding of the execution logic among the nodes in the process instance, thereby ensuring accuracy and reliability of the process execution.

Optionally, the process orchestration engine further may determine the process instance and the branch to which the asynchronous node belongs based on the process instance identifier and the branch identifier in the data submitted by the user, locate current asynchronous node in this branch based on the node identifier in the data submitted by the user, and then continue the execution forwards. That is, the node pointer may not be checked, and even the node pointer may not be implemented.

Optionally, in the embodiments of the present disclosure, the target page includes a form page or an examination and approval page. If the target page corresponding to a certain asynchronous node is a form page, it also may be called as a form node. If the target page corresponding to a certain asynchronous node is an examination and approval page, it also may be called as an examination and approval node.

In the above, the target page refers to a page where the user submits data, the form page may be a page for collecting data input by the user, and the data may form the form of the user. The form page may include input control corresponding to each field in the form, for receiving input of the user, for example, text box, pull-down list, check box, and radio button. The user may input form data on the form page, and submit the form data and respective identifiers of form nodes in the form page address to the process orchestration engine.

The examination and approval page is a page for handling and managing examination and approval tasks. The examination and approval page is used to display application or task subject to examination approval, and provides an interface for the approvers to make a decision on requests. For example, the interface may include buttons such as Approve and Reject, and text box for examination and approval opinion. The user may fill in examination and approval opinion and examination and approval result on the examination and approval page, and submit the examination and approval opinion, examination and approval result as well as identifiers of examination and approval nodes in the address on the examination and approval page to the process orchestration engine. Optionally, some examination and approval pages also allow the user to input some data other than the examination and approval opinion and the examination and approval result. The examination and approval page also may be regarded as a special case of form page.

During the above implementation, the target page corresponding to the asynchronous node includes the form page or the examination and approval page. Target pages in different forms may implement different services, which is conducive to improving the usability of the process orchestration engine, and particularly makes it suitable for some enterprise scenarios, because in enterprises, filling in forms and approval and examination are common services.

For example, in combination with the loop node in the service process, the embodiments of the present disclosure may implement a complex and flexible examination and approval process. For example, if the loop node includes an examination and approval node, and the concurrent attribute of the loop node is set to be non-concurrent execution, a serial examination and approval process may be implemented. If the concurrent attribute of the loop node is set to be concurrent execution, a parallel examination and approval process may be implemented. If the loop nodes are nested, a more complex examination and approval process may be implemented.

In the embodiments of the present disclosure, an entity may refer to definition of data, for example, defining which fields are included in a data table. The form is a presentation form of an entity, for example, different users are allowed to see different fields in the data table, so that different forms may be formed based on the same entity. A form instance is a form containing actual data. Different form instances may be distinguished by a form instance identifier, which may be represented by Entity Data ID.

Optionally, in the embodiments of the present disclosure, if the target page is a form page of a new form (namely, a form without data), the execution procedure of the asynchronous node is as described in the preceding. Upon receipt of the form data submitted by the user, the process orchestration engine may allocate one form instance identifier to the form data. Certainly, a case where the user specifies the form instance identifier (in the node parameters) is not excluded, and if the user specifies the form instance identifier, the form instance identifier may be submitted to the process orchestration engine along with the form data.

If the target page is a form page of an edited form, the step of splicing the node identifier, the process instance identifier and the branch identifier of the asynchronous node so as to generate an address of the target page includes: acquiring the form instance identifier corresponding to the edited form; splicing the node identifier, the process instance identifier and the branch identifier of the asynchronous node as well as the form instance identifier, so as to generate the address of the target page, wherein the form instance identifier is used to query form data of the edited form, and the form data is used to render the target page; and the data submitted by the user on the target page includes: the updated form data, the node identifier, the process instance identifier and the branch identifier of the asynchronous node, and the form instance identifier.

In the above, that the target page is a form page of an edited form may include following situations: a first situation, in which, for example, if the form data that has been submitted by the user needs to be modified or edited secondarily, the data submitted by the user is taken as the data in the form page of the edited form; and a second situation, in which the edited form is a previously stored form, for example, an examination and approval form needs to be examined and approved by multiple people or a data form needs to be filled in by multiple people, the following filling-in is examination and approval or filling-in based on the previous data, and after examining and approving or filling in by each person, the updated data is stored, and the edited form is taken as a form to be presented on the target page of next user.

If the target page is the form page of the edited form, when generating the address of the target page, the form instance identifier corresponding to the edited form further needs to be spliced into the address of the target page. Generation of the address of the target page is described in detail below. The form instance identifier corresponding to the edited form is acquired, wherein the form instance identifier corresponding to the edited form is generated after the form is submitted for the first time. The form instance identifier may be generated by the user in a customized manner, and also may be automatically generated after the process orchestration engine acquires the data submitted by the user for the target page. Subsequent processing on the edited form may continue to use the form instance identifier generated after the form is submitted for the first time.

The form instance identifier may be used to query form data of the edited form, and the form data is used to render the target page, so that the user learns the contents of the edited form. Taking the edited form in the first situation as an example, the user needs to modify the submitted form data, and the form instance identifier of this form is generated after the user submits the data for the first time. After notifying the user of the address of the form page of the edited form, the user clicks on the address, and the process orchestration engine may query the form data submitted by the user for the first time through the form instance identifier spliced in the address, so that the form page of the edited form may be rendered based on the form data and this page may be returned to the user, and the user may modify the form data on this basis.

Correspondingly, if the target page is the form page of the edited form, the data submitted by the user on the target page includes: the updated form data, the node identifier, the process instance identifier and the branch identifier of the asynchronous node, and the form instance identifier. Upon receipt of the data submitted by the user, the process orchestration engine may continue to execute subsequent nodes in the service process, which may specifically refer to the preceding contents and will not be repeated. In addition, the process orchestration engine further may manage the updated form data based on the form instance identifier submitted by the user on the target page.

During the above implementation, in the case where the target page is the form page of the edited form, the form instance identifier may be spliced in the address of the target page, and the form data is presented to the user on the target page, so that the user may re-edit on the basis of the edited form, thereby implementing reuse of the form data.

Optionally, in the embodiments of the present disclosure, after generating the address of the target page, the process orchestration engine needs to notify the user of the address of the target page, so that the user enters the target page based on the address of the target page, and executes corresponding external action. Preset methods of notifying the user include: a first method: obtaining user information of a user executing an external action corresponding to the asynchronous node, and sending notification information to the user based on the user information, wherein the notification information includes an address of the target page; a second method: obtaining a to-do item list of the user, and generating a target representative item according to the address of the target page, wherein the target representative item is used to instruct the user to enter the target page, and adding the target representative item to the to-do item list of the user; and a third method: obtaining a data list of the user, generating an interaction button based on the address of the target page, wherein the interaction button is used to instruct the user to enter the target page, and adding the interaction button to the data list of the user.

The first method is sending to the user information carrying the address of the target page therein. Specifically for example, the user information of the user is obtained, wherein the user is a user executing the external action corresponding to the asynchronous node; and the user information is personal information of the user through which messages, such as an account on a social platform, a mobile phone number or user Email may be received. After the user information is acquired, notification information including the address of the target page is sent to the user.

The second method is generating to-do items of the user based on the address of the target page. For example, the to-do item list of the user is obtained, wherein the to-do item list may be a to-do item list of the user in a task management system, or a to-do item list of the user in a personal workflow. For example, the to-do item list may include one or more to-do items, each to-do item may be a text description of the to-do item, and the text description meanwhile contains one page address that is correspondingly for completing the to-do item.

The process orchestration engine may generate a target to-do item according to the address of the target page, and the text description of the target to-do item may be composed of purpose of the target page, contents of the target page, and name of user to use the target page and other information, and the information may be queried from a database by the process orchestration engine.

After generating the target to-do item, the process orchestration engine may add the target to-do item to the to-do item list of the user, and also may send to the user a prompt message of to-do item being added. The user may enter the target page by clicking on the page address corresponding to the target to-do item, and complete the external action corresponding to the asynchronous node, such as filling in a form or examining and approving data.

The third method is adding a button for entering the target page to the data list of the user. For example, the data list of the user is obtained, wherein the data list may be located in a system of the user, and the user can see this data list when entering a specific page in the system. An interaction button is added to the data list of the user, wherein the interaction button is used to instruct the user to enter the target page. The interaction button is corresponding to the address of the target page. An interaction button response event is created by writing codes so as to open corresponding target page when the user clicks on the interaction button.

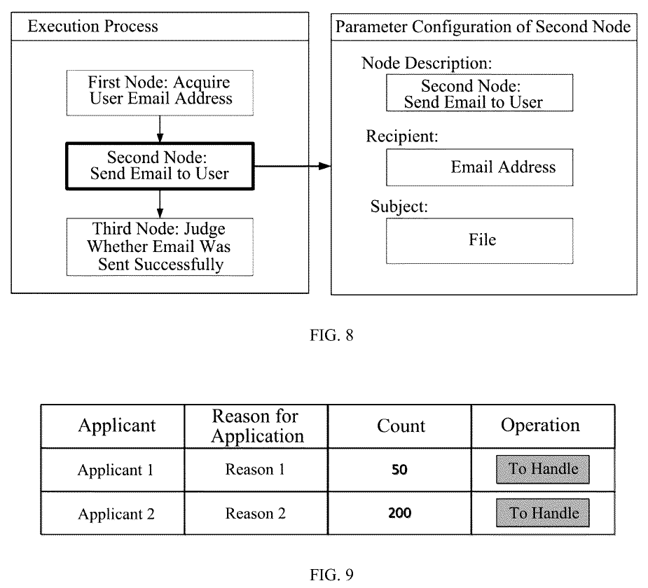

FIG. 9 is a schematic diagram of a data table containing interaction buttons provided in embodiments of the present disclosure. FIG. 9 shows a data list that may be seen by one approver. Each time a piece of examination and approval information is generated in the system, an entry is added to this data list, wherein the last column of the entry is an interaction button corresponding to an examination and approval page, and after clicking on the button, the approver can access this page to execute the external action corresponding to the examination and approval node.

During the above implementation, diversified and flexible methods of notifying the user are provided, and a corresponding method may be chosen according to specific application scenarios and page requirements of the target page, so that the user acquires the address of the target page, thereby entering the target page to complete the external action corresponding to the asynchronous node.

Optionally, in the embodiments of the present disclosure, if the external action corresponding to the asynchronous node is an action of a third party calling back the target function, the step of executing the asynchronous node in step S120 includes: storing the node identifier, the process instance identifier and the branch identifier of the asynchronous node in association with a function identifier of the target function corresponding to the asynchronous node; sending the function identifier to the third party by calling an interface provided by the third party; and determining, in response to the third party calling the target function through the function identifier, the node identifier, the process instance identifier and the branch identifier of the asynchronous node stored in association with the function identifier, according to the function identifier of the called target function.

In the above, the external action corresponding to the asynchronous node further may be an action of the third party calling back the target function. A callback function is a function called when a specific event occurs. For example, the target function may be a WebHook-type function, and certainly also may be a function of other types defined by the process orchestration engine.

The step of executing the asynchronous node is described below by taking WebHook function as an example. WebHook includes a function identifier, which is used to identify different WebHook functions. The function identifier of WebHook may be represented by WebHook id. Before executing the asynchronous node, the process orchestration engine firstly stores the node identifier, the process instance identifier and the branch identifier of the asynchronous node in association with the function identifier of the target function corresponding to the asynchronous node, for example, stores them in a database.

Next, the process orchestration engine obtains an interface provided by a third party, which may be an interface having a specific function, such as a message push interface. The third party may be software that needs to call the WebHook function. The interface is called based on description or requirement of the interface provided by the third party, and call parameters include WebHook id.

After receiving the WebHook id, the third party calls (calls back) WebHook based on the WebHook id. The process orchestration engine queries, in response to the third party calling the WebHook through the WebHook id, the node identifier, the process instance identifier and the branch identifier of the asynchronous node stored in association with this WebHook id, according to the WebHook id of the called WebHook function.

During the above implementation, the process orchestration engine only needs to transmit the WebHook id to the third party, without transmitting the node identifier, the process instance identifier and the branch identifier, so that the asynchronous node is executed more efficiently and simply.

After obtaining the data queried, the process orchestration engine may continue to execute nodes (if any) after the asynchronous node in the service process. Alternatively, if the asynchronous node is provided with a timeout mechanism, the process orchestration engine also may mandatorily execute subsequent nodes after the execution of the asynchronous node times out.

During the above implementation, the external action corresponding to the asynchronous node also may be the action of the third party calling back the target function. By sending the function identifier to the third party, the node identifier, the process instance identifier and the branch identifier of the asynchronous node stored in association with the function identifier are determined according to the function identifier of the called target function. Through these identifiers, the branch under the process instance to which the asynchronous node belongs may be located, so that the nodes after the asynchronous node continue to be executed. That is, through the above implementation procedure, the asynchronous node is supported at the execution level (the node selection operation has already achieved support to the asynchronous node at the interface level).

In addition, it also may be seen that the asynchronous node in the embodiments of the present disclosure may support external actions in many application scenarios (for example, people-executed actions such as filling in form and examination and approval, and machine-executed function callback action), so as to better meet diversified orchestration requirements of practical service process, and effectively enhance compatibility and usability of the process orchestration engine.

Optionally, in the embodiments of the present disclosure, a node pointer is provided for each branch in each process instance, and the pointer points to the node currently executed in the branch. After the node identifier, the process instance identifier and the branch identifier of the asynchronous node stored in associated with the function identifier are determined, the method further includes: determining a target node pointer based on the process instance identifier and the branch identifier of the asynchronous node, wherein the target node pointer refers to the node pointer corresponding to the process instance and the branch to which the asynchronous node belongs; and if the node identifier of the asynchronous node is consistent with the node identifier of the node to which the target node pointer points, continuing to execute the nodes after the asynchronous node in the service process.

The node pointer has been described in the preceding, and will not be repeated. After determining the node identifier, the process instance identifier and the branch identifier of the asynchronous node stored in association with the function identifier, the process orchestration engine may determine the target node pointer based on the process instance identifier and the branch identifier of the asynchronous node, wherein the target node pointer refers to a node pointer corresponding to the process instance and the branch to which the asynchronous node belongs, the process instance to which the asynchronous node belongs is determined according to the process instance identifier submitted by the user, while the branch to which the asynchronous node belongs is determined according to the branch identifier submitted by the user.

The node identifier of the asynchronous node queried according to the function identifier is compared with the node identifier of the node to which the target node pointer points, to see whether they are consistent. If the node identifier of the asynchronous node is consistent with the node identifier of the node to which the target node pointer points, it indicates that before the branch to which the target node pointer belongs, the position of the asynchronous node is just to be executed, after that the execution process is suspended, and is waiting for the third party to call back the target function, wherein the third party just calls the target function corresponding to the asynchronous node, and the external action that the asynchronous node waits for has been completed, so that the process orchestration engine may continue to execute the nodes after the asynchronous node in the service process. If the node identifier of the asynchronous node is inconsistent with the node identifier of the node to which the target node pointer points, an exception may be thrown.

During the above implementation, by comparing the node identifier of the asynchronous node with the node identifier of the node to which the target node pointer points to see whether they are consistent, it is judged whether to continue to execute the nodes after the asynchronous node, so as to control and manage forwarding of the execution logic among the nodes in the process instance, thereby ensuring accuracy and reliability of the process execution.

Optionally, the process orchestration engine further may determine the process instance and the branch to which the asynchronous node belongs based on the process instance identifier and the branch identifier queried using the function identifier, and locate current asynchronous node in this branch based on the node identifier queried using the function identifier, and then continue the execution forwards. That is, the node pointer may not be checked, and even the node pointer may not be implemented.

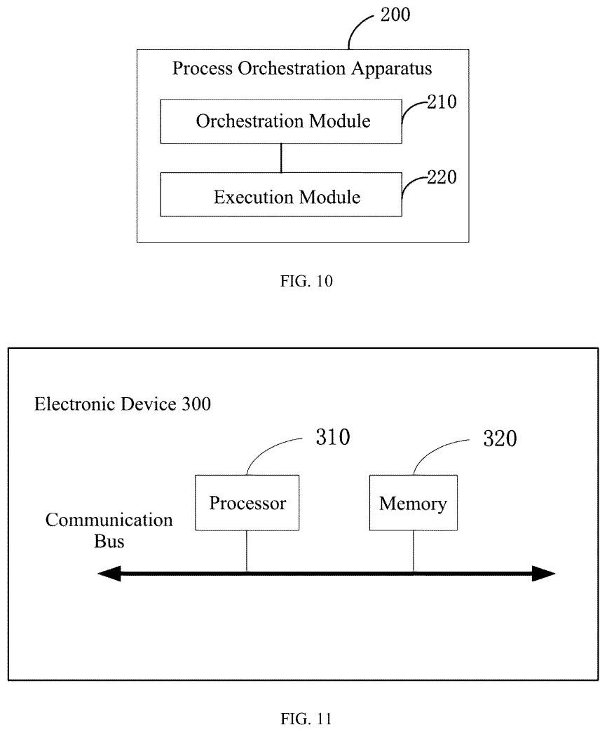

With reference to FIG. 10, it shows a structural schematic diagram of a process orchestration apparatus provided in embodiments of the present disclosure. Embodiments of the present disclosure provide a process orchestration apparatus 200, including:
an orchestration module 210, configured to generate a to-be-orchestrated service process, in response to a node selection operation and a node parameter configuration operation based on an interface, wherein nodes supported for selection by the node selection operation include synchronous nodes and asynchronous nodes, and wherein the synchronous nodes represent tasks which can be executed without waiting for an external action, and the asynchronous nodes represent tasks which need to wait for an external action to be executed; and
an execution module 220, configured to execute the nodes in the service process successively according to an order of the nodes in the service process.

Optionally, in the embodiments of the present disclosure, for the process orchestration apparatus, attributes of the nodes include node identifier, process instance identifier and branch identifier, wherein the node identifier is used to identify different nodes in the service process; each time the service process runs, one process instance is generated, and the process instance identifier is used to identify the process instance to which the node belongs; the process instance includes one or more branches, and the branch identifier is used to identify a branch to which the node belongs; and the branch is a concurrent execution branch in the process instance.

Optionally, in the embodiments of the present disclosure, for the process orchestration apparatus, if the external action corresponding to the asynchronous node is an action of the user submitting data on a target page, the execution module is further configured to obtain the node identifier, the process instance identifier and the branch identifier of the asynchronous node; splice the node identifier, the process instance identifier and the branch identifier of the asynchronous node, so as to generate an address of the target page; notify the user executing the external action corresponding to the asynchronous node of the address of the target page in a preset method; and receive data submitted by the user on the target page, wherein the data includes service data, the node identifier, the process instance identifier and the branch identifier of the asynchronous node.

Optionally, in the embodiments of the present disclosure, for the process orchestration apparatus, a node pointer is provided for each branch in the process instance, and the node pointer points to a node currently executed in the branch. A first pointer judgment module is further included, and is configured to obtain the node identifier, the process instance identifier and the branch identifier of the asynchronous node from the data submitted by the user; and determine a target node pointer based on the process instance identifier and the branch identifier, wherein the target node pointer refers to the node pointer corresponding to the process instance and the branch to which the asynchronous node belongs. If the node identifier of the asynchronous node is consistent with the node identifier of the node to which the target node pointer points, nodes after the asynchronous node in the service process continue to be executed.

Optionally, in the embodiments of the present disclosure, for the process orchestration apparatus, the target page includes a form page or an examination and approval page.

Optionally, in the embodiments of the present disclosure, for the process orchestration apparatus, if the target page is the form page of an edited form, the execution module is further configured to acquire a form instance identifier corresponding to the edited form; splice the node identifier, the process instance identifier and the branch identifier of the asynchronous node as well as the form instance identifier, so as to generate an address of the target page, wherein the form instance identifier is used to query form data of the edited form, and the form data is used to render the target page; and the data submitted by the user on the target page includes: the updated form data, the node identifier, the process instance identifier and the branch identifier of the asynchronous node, and the form instance identifier.

Optionally, in the embodiments of the present disclosure, for the process orchestration apparatus, preset methods of notifying a user for the external action corresponding to the asynchronous node include: a first method: obtaining user information of the user executing the external action corresponding to the asynchronous node, and sending notification information to the user based on the user information, wherein the notification information includes the address of the target page; a second method: obtaining a to-do item list of the user, and generating a target representative item according to the address of the target page, wherein the target representative item is used to instruct the user to enter the target page; and adding the target representative item to the to-do item list of the user; and a third method: obtaining a data list of the user; generating an interaction button based on the address of the target page, wherein the interaction button is used to instruct the user to enter the target page; and adding the interaction button to the data list of the user.

Optionally, in the embodiments of the present disclosure, for the process orchestration apparatus, if the external action corresponding to the asynchronous node is an action of a third party calling back a target function, the execution module is further configured to store the node identifier, the process instance identifier and the branch identifier of the asynchronous node in association with a function identifier of the target function corresponding to the asynchronous node; send the function identifier to the third party by calling an interface provided by the third party; and determine, in response to the third party calling the target function through the function identifier, the node identifier, the process instance identifier and the branch identifier of the asynchronous node stored in association with the function identifier, according to the function identifier of the called target function.

Optionally, in the embodiments of the present disclosure, for the process orchestration apparatus, a node pointer is provided for each branch in the process instance, and the pointer points to a node currently executed in the branch. A second pointer judgment module is configured to determine a target node pointer based on the process instance identifier and the branch identifier of the asynchronous node, wherein the target node pointer refers to the node pointer corresponding to the process instance and the branch to which the asynchronous node belongs; and if the node identifier of the asynchronous node is consistent with the node identifier of the node to which the target node pointer points, continue to execute nodes after the asynchronous node in the service process.

Optionally, in the embodiments of the present disclosure, for the process orchestration apparatus, the nodes include a loop node. The loop node is a node that requires repeated execution of a child node in a loop body until a loop ending condition is met. Parameters of the loop node include concurrent attribute. The execution module is further configured to, when executing the loop node, if the concurrent attribute of the loop node is configured to be concurrent execution, generate secondary branches whose number is the same as a total number of values of a loop variable of the loop node, under a branch to which the loop node belongs; and concurrently execute the loop body under each value of the loop variable using the secondary branches; and executing the loop node, if the concurrent attribute of the loop node is configured to be non-concurrent execution, repeatedly execute the loop body according to change of the loop variable using the branch to which the loop node belongs.

Optionally, in the embodiments of the present disclosure, for the process orchestration apparatus, if the concurrent attribute of the loop node is configured to be concurrent execution, an execution result of the loop node is obtained according to execution result corresponding to each secondary branch.

Optionally, in the embodiments of the present disclosure, the process orchestration apparatus further includes a branch destroy module, configured to, if the concurrent attribute of the loop node is configured to be concurrent execution, make the loop ending condition include: each secondary branch is executed, an instruction that needs to end the loop early is executed in any one of the secondary branches or execution of any one of the secondary branches times out; and after the execution of the loop node is completed, destroy the generated secondary branches, and continue to execute the nodes in the service process using the branch to which the loop node belongs.

Optionally, in the embodiments of the present disclosure, for the process orchestration apparatus, generation rules of the branch identifier of the node include: if the node is not a child node of the loop node whose concurrent attribute is configured to be concurrent execution, the branch identifier of the node is consistent with the process instance identifier; if the node is a child node of the loop node whose concurrent attribute is configured to be concurrent execution, the branch identifier of the node is generated according to the branch identifier of the loop node, which is closest to the node among parent nodes of the child node and whose concurrent attribute is configured to be concurrent execution, as well as a loop serial number corresponding to the node, wherein the loop serial number corresponding to the node is a serial number of current value of loop variable corresponding to the branch to which the node belongs in all values.

Optionally, in embodiments of the present disclosure, the service process includes a first node and a second node, wherein the execution order of the first node is before the second node; the node identifier, the process identifier and the branch identifier of the node are stored in association after the execution of the node is completed; if parameters configured for the second node include reference to the execution result of the first node, the process orchestration apparatus further includes an execution result obtaining module, configured to acquire the node identifier and the process identifier of the first node; query nodes whose execution order is before the second node in the service process according to a reverse order of an execution order of the service process, with the second node as a starting point, and determine the branch identifier of each queried node according to the generation rules of the branch identifier and the branch identifier of the second node during the query; determine the branch identifier of the first node as the branch identifier of the queried node until the node identifier of the queried node is the node identifier of the first node; and acquire the execution result of the first node stored in association with the node identifier, the process identifier and the branch identifier of the first node.

It should be understood that the apparatus is corresponding to the above embodiments of the process orchestration method and can carry out the steps involved in the above method embodiments. Specific functions of the apparatus can be found in the above description, and detailed description is appropriately omitted herein to avoid repetition. The apparatus includes at least one software functional module that can be stored in a memory in a form of software or firmware or solidified in an operating system (OS) of the apparatus.

With reference to FIG. 11, it shows a structural schematic diagram of an electronic device provided in embodiments of the present disclosure. Embodiments of the present disclosure provide an electronic device 300, including: a processor 310 and a memory 320, wherein the memory 320 stores machine-readable instructions executable by the processor 310, and the above method is executed when the machine-readable instructions are executed by the processor 310.

Embodiments of the present disclosure further provide a storage medium, wherein the storage medium stores computer programs, and the above method is executed when the computer programs are executed by the processor.

In the above, the storage medium may be implemented by any type of volatile or non-volatile storage device or combination thereof, for example, static random access memory (SRAM for short), electrically erasable programmable read-only memory (EEPROM for short), erasable programmable read-only memory (EPROM for short), programmable read-only memory (PROM for short), read-only memory (ROM for short), magnetic memory, flash memory, magnetic disk and optical disk.

In several embodiments provided in the embodiments of the present disclosure, it should be understood that the disclosed apparatus and method also may be implemented in other manners. The apparatus embodiments described above are merely exemplary, for example, the flowcharts and block diagrams in the drawings show possible system architectures, functions and operations of the apparatus, method and computer program product of embodiments according to the embodiments of the present disclosure. In this regard, each block in the flowcharts or block diagrams may represent a part of a module, program segment or code, and the part of the module, program segment, or code contains one or more executable instructions configured to achieve a specified logical function. It also should be noted that, in some alternative embodiments, the functions noted in the blocks also may occur in an order other than the order noted in the drawings. For example, two continuous blocks actually may be substantially executed concurrently, or they sometimes also may be executed in a reverse order, which depends upon functions involved. It is also to be noted that each block in the block diagrams and/or flowcharts, and combinations of blocks in the block diagrams and/or flowcharts, may be implemented in application specific hardware-based systems that perform specified functions or actions, or may be implemented by a combination of application specific hardware and computer instructions.

Besides, various functional modules in various embodiments of the present disclosure may be integrated together to form one independent part, various modules also may exist independently, or two or more modules may be integrated to form one independent part.

The above description is merely for optional embodiments of the embodiments of the present disclosure, but the scope of protection of the embodiments of the present disclosure is not limited thereto. Any change or substitution that may easily occur to those skilled in the present art within the technical scope disclosed in the embodiments of the present disclosure should be covered within the scope of protection of the embodiments of the present disclosure.

What is claimed is:

1. A process orchestration method, comprising:
generating a to-be-orchestrated service process, in response to a node selection operation and a node parameter configuration operation based on an interface, wherein nodes supported for selection by the node selection operation comprise synchronous nodes and asynchronous nodes, wherein the synchronous nodes represent tasks which are capable of being executed without waiting for an external action, and the asynchronous nodes represent tasks which need to wait for an external action to be executed; and
executing the nodes in the service process successively according to an order of the nodes in the service process.

2. The method according to claim 1, wherein attributes of the nodes comprise node identifier, process instance identifier and branch identifier,
wherein the node identifier is used to identify different nodes in the service process;
each time the service process runs, one process instance is generated, and the process instance identifier is used to identify the process instance to which the node belongs; and
the process instance comprises one or more branches, and the branch identifier is used to identify a branch to which the node belongs; and the branch is a concurrent execution branch in the process instance.

3. The method according to claim 2, wherein if the external action corresponding to the asynchronous node is an action of a user submitting data on a target page, a step of executing the asynchronous node comprises:
obtaining the node identifier, the process instance identifier and the branch identifier of the asynchronous node;
splicing the node identifier, the process instance identifier and the branch identifier of the asynchronous node, so as to generate an address of the target page;
notifying the user executing the external action corresponding to the asynchronous node of the address of the target page in preset modes; and
receiving data submitted by the user on the target page, wherein the data comprises service data, and the node identifier, the process instance identifier and the branch identifier of the asynchronous node.

4. The method according to claim 3, wherein a node pointer is provided for each branch in the process instance, and the node pointer points to a node currently executed in the branch, wherein after the data submitted by the user on the target page is received, the method further comprises:
obtaining the node identifier, the process instance identifier and the branch identifier of the asynchronous node from the data submitted by the user;
determining a target node pointer based on the process instance identifier and the branch identifier, wherein the target node pointer refers to the node pointer corresponding to the process instance and the branch to which the asynchronous node belongs,
wherein if the node identifier of the asynchronous node is consistent with the node identifier of the node to which the target node pointer points, continue to execute nodes after the asynchronous node in the service process.

5. The method according to claim 3, wherein the target page comprises a form page or an examination and approval page.

6. The method according to claim 5, wherein if the target page is a form page of an edited form, the step of splicing the node identifier, the process instance identifier and the branch identifier of the asynchronous node so as to generate an address of the target page comprises:
acquiring the form instance identifier corresponding to the edited form;
splicing the node identifier, the process instance identifier and the branch identifier of the asynchronous node and the form instance identifier, so as to generate the address of the target page, wherein the form instance identifier is used to query form data of the edited form, and the form data is used to render the target page,
wherein the data submitted by the user on the target page comprises: the updated form data, the node identifier, the process instance identifier and the branch identifier of the asynchronous node, and the form instance identifier.

7. The method according to claim 3, wherein the preset modes of notifying a user for the external action corresponding to the asynchronous node comprise:
a first mode: obtaining user information of the user executing the external action corresponding to the asynchronous node, and sending notification information to the user based on the user information, wherein the notification information comprises the address of the target page;
a second mode: obtaining a to-do item list of the user, and generating a target representative item according to the address of the target page, wherein the target representative item is used to instruct the user to enter the target page; and adding the target representative item to the to-do item list of the user; and
a third mode: obtaining a data list of the user; generating an interaction button based on the address of the target page, wherein the interaction button is used to instruct the user to enter the target page; and adding the interaction button to the data list of the user.

8. The method according to claim 2, wherein if the external action corresponding to the asynchronous node is an action of a third party calling back a target function, the step of executing the asynchronous node comprises:
storing the node identifier, the process instance identifier and the branch identifier of the asynchronous node in association with a function identifier of the target function corresponding to the asynchronous node;
sending the function identifier to the third party by calling an interface provided by the third party; and
determining the node identifier, the process instance identifier and the branch identifier of the asynchronous node stored in association with the function identifier, in response to the third party calling the target function through the function identifier, according to the function identifier of the called target function.

9. The method according to claim 8, wherein a node pointer is provided for each branch in the process instance, and the node pointer points to a node currently executed in the branch, wherein after the node identifier, the process instance identifier and the branch identifier of the asynchronous node stored in associated with the function identifier are determined, the method further comprises:
determining a target node pointer based on the process instance identifier and the branch identifier of the asynchronous node, wherein the target node pointer refers to the node pointer corresponding to the process instance and the branch to which the asynchronous node belongs,
wherein if the node identifier of the asynchronous node is consistent with the node identifier of the node to which the target node pointer points, continue to execute the nodes after the asynchronous node in the service process.

10. The method according to claim 2, wherein the nodes comprise a loop node, the loop node is a node which requires repeated execution of a child node in a loop body until a loop ending condition is met; and parameters of the loop node comprise concurrent attribute,
wherein when the loop node is to be executed, if the concurrent attribute of the loop node is configured to be concurrent execution, secondary branches, whose number is the same as a total number of values of a loop variable of the loop node, are generated under a branch to which the loop node belongs; and the loop body under each value of the loop variable is concurrently executed using the secondary branches; and
when the loop node is to be executed, if the concurrent attribute of the loop node is configured to be non-concurrent execution, the loop body is repeatedly executed according to change of the loop variable using the branch to which the loop node belongs.

11. The method according to claim 10, wherein if the concurrent attribute of the loop node is configured to be concurrent execution, an execution result of the loop node is obtained according to execution result corresponding to each secondary branch.

12. The method according to claim 10, wherein if the concurrent attribute of the loop node is configured to be concurrent execution, the loop ending condition comprises: execution of each secondary branch is completed, an instruction that needs to end the loop early is executed in any one of the secondary branches, or execution of any one of the secondary branches times out,
wherein after execution of the loop node is completed, the generated secondary branches are destroyed, and the nodes in the service process continue to be executed using the branch to which the loop node belongs.

13. The method according to claim 10, wherein generation rules of the branch identifier of the node comprise:
if the node is not a child node of the loop node whose concurrent attribute is configured to be concurrent execution, the branch identifier of the node is consistent with the process instance identifier; and
if the node is a child node of the loop node whose concurrent attribute is configured to be concurrent execution, the branch identifier of the node is generated according to the branch identifier of the loop node, which is closest to the node among parent nodes of the child node and whose concurrent attribute is configured to be concurrent execution, and a loop serial number corresponding to the node, wherein the loop serial number corresponding to the node is a serial number of current value of loop variable corresponding to the branch to which the node belongs in all values.

14. The method according to claim 13, wherein the service process comprises a first node and a second node, wherein an execution order of the first node is before the second node; the node identifier, the process identifier and the branch identifier of the node are stored in association after execution of the node is completed,
wherein if parameters configured for the second node comprise reference to the execution result of the first node, a step of obtaining the execution result of the first node comprises:
acquiring the node identifier and the process instance identifier of the first node;
querying nodes whose execution order are before the second node in the service process according to a reverse order of an execution order of the service process, with the second node as a starting point, and determining the branch identifier of each queried node according to the generation rules of the branch identifier and the branch identifier of the second node during the query; determining the branch identifier of the first node as the branch identifier of the queried node until the node identifier of the queried node is the node identifier of the first node; and
acquiring the execution result of the first node stored in association with the node identifier, the process instance identifier and the branch identifier of the first node.

15. An electronic device, comprising a processor and a memory, wherein the memory stores machine-readable instructions executable by the processor, and the machine-readable instructions, when executed by the processor, execute the method according to claim 1.

16. A computer-readable storage medium, storing computer programs thereon, wherein the computer programs, when executed by the processor, execute the method according to claim 1.

17. The electronic device according to claim 15, wherein attributes of the nodes comprise node identifier, process instance identifier and branch identifier,
wherein the node identifier is used to identify different nodes in the service process;
each time the service process runs, one process instance is generated, and the process instance identifier is used to identify the process instance to which the node belongs; and
the process instance comprises one or more branches, and the branch identifier is used to identify a branch to which the node belongs; and the branch is a concurrent execution branch in the process instance.

18. The electronic device according to claim 17, wherein if the external action corresponding to the asynchronous node is an action of a user submitting data on a target page, a step of executing the asynchronous node comprises:
obtaining the node identifier, the process instance identifier and the branch identifier of the asynchronous node;
splicing the node identifier, the process instance identifier and the branch identifier of the asynchronous node, so as to generate an address of the target page;
notifying the user executing the external action corresponding to the asynchronous node of the address of the target page in preset modes; and
receiving data submitted by the user on the target page, wherein the data comprises service data, and the node identifier, the process instance identifier and the branch identifier of the asynchronous node.

19. The electronic device according to claim 18, wherein a node pointer is provided for each branch in the process instance, and the node pointer points to a node currently executed in the branch, wherein after the data submitted by the user on the target page is received, the method further comprises:
obtaining the node identifier, the process instance identifier and the branch identifier of the asynchronous node from the data submitted by the user;
determining a target node pointer based on the process instance identifier and the branch identifier, wherein the target node pointer refers to the node pointer corresponding to the process instance and the branch to which the asynchronous node belongs,
wherein if the node identifier of the asynchronous node is consistent with the node identifier of the node to which the target node pointer points, continue to execute nodes after the asynchronous node in the service process.

20. The electronic device according to claim 18, wherein the target page comprises a form page or an examination and approval page.
